(19) United States
(12) Patent Application Publication
(10) Pub. No.: US 2026/0341766 A1
(43) Pub. Date: Oct. 29, 2026

(54) ELECTROCHEMICAL REACTION DEVICE

(71) Applicant: KABUSHIKI KAISHA TOSHIBA, Kawasaki-shi (JP)

(72) Inventors: Naoya FUJIWARA, Toshima (JP); Ryota KITAGAWA, Setagaya (JP); Masakazu YAMAGIWA, Yokohama (JP); Yuki KUDO, Yokohama (JP); Toshiro HIRAOKA, Yokohama (JP)

(73) Assignee: KABUSHIKI KAISHA TOSHIBA, Kawasaki-shi (JP)

(21) Appl. No.: 19/539,502

(22) Filed: Feb. 13, 2026

(30) Foreign Application Priority Data
Mar. 19, 2025 (JP) 2025-044861

(51) Int. Cl. H01M 8/12; H01M 8/0258; H01M 8/0273

(52) U.S. Cl. CPC H01M 8/12; H01M 8/0258; H01M 8/0273

(57) ABSTRACT

An electrochemical reaction device includes: an electrolysis cell stack including: a plurality of sub-stacks stacked between a pair of clamping plates, each sub-stack including: a plurality of electrolysis cells stacked between a pair of support plates; and at least one fluid manifold completed within one of the plural sub-stacks; a measuring device to measure a physical quantity related to a state of at least one of the plural sub-stacks to acquire physical quantity data; and an information processing unit to process the physical quantity data from the measuring device. Each electrolysis cell includes: a cathode chamber; an anode chamber; a diaphragm between the cathode chamber and the anode chamber; a cathode arranged on the cathode chamber; and an anode arranged on the anode chamber. The pair of support plates includes at least four through holes including an inlet or an outlet of the at least one fluid manifold.

### CROSS-REFERENCE TO RELATED APPLICATIONS

This application is based upon and claims the benefit of priority from Japanese Patent Application No. 2025-044861, filed on Mar. 19, 2025; the entire contents of which are incorporated herein by reference.

### FIELD

Embodiments relate to an electrochemical reaction device.

### BACKGROUND

In recent years, there has been a concern over the depletion of fossil fuel resources such as petroleum and coal, and expectations of sustainable renewable energy have increased. Examples of renewable energy include solar cells, wind power generation, and so on. These face the challenge of unstable power supply because their generation capacity depends on weather or natural conditions. For this reason, attempts have been made to store electric power generated from renewable energy sources in storage batteries to stabilize the electric power. However, storing electric power comes with problems such as the cost of storage batteries and the occurrence of power losses during storage.

In response to this point, the techniques that convert electric energy into chemical substances (chemical energy) have been attracting attention, which are producing hydrogen from water by performing water electrolysis using electric power generated from renewable energy, producing carbon compounds such as carbon monoxide, formic acid, methanol, methane, acetic acid, ethanol, ethane, and ethylene by electrochemically reducing carbon dioxide, and producing ammonia by electrochemically reducing nitrogen. Storing these chemical substances in a cylinder or a tank has advantages of being lower in energy storage cost and smaller in storage loss than storing electric power (electric energy) in the storage battery.

Such an electrochemical reaction is typically conducted in a device equipped with electrolysis cells or cell stacks composed of stacked electrolysis cells. The operation mode of an electrochemical reaction device can vary depending on the type of reaction or its intended purpose. For example, the electrochemical reaction device may be operated continuously for long periods of time, or may undergo frequent start-stop cycles. The continuous operation or the start-stop operation sometimes causes performance deterioration of an electrolysis cell stack, such as, for example, an increase in cell voltage, a decrease in product selectivity, and a decrease in current efficiency. The causes of this performance deterioration can be attributed to various physicochemical phenomena within the electrolysis cell stack, such as, for example, electrode deterioration, membrane deterioration, and changes in the distribution of liquids and gases. Therefore, on the electrolysis cell stack whose performance has deteriorated or is expected to deteriorate, maintenance such as changing operating conditions or replacing members can be performed to restore the performance or prevent the performance deterioration. On the other hand, electrolysis cell stacks to be used in industry are often formed by stacking a plurality of electrolysis cells, and the cause of the performance deterioration in the electrolysis cell stack is often attributable only to a specific electrolysis cell. In such cases, performing maintenance on all the electrolysis cells would be wasteful in terms of time or cost. To perform efficient maintenance, it is necessary to specify the part that is causing the performance deterioration and take measures only for that part.

### BRIEF DESCRIPTION OF THE DRAWINGS

FIG. 1 is a schematic view illustrating a configuration example of an electrochemical reaction device;

FIG. 2 is a schematic view illustrating a structure example of an electrolysis cell stack 10;

FIG. 3 is a view illustrating a cathode fluid path and an anode fluid path in the electrolysis cell stack 10;

FIG. 4 is a schematic view illustrating another structure example of the electrolysis cell stack 10 in an electrochemical reaction device 1;

FIG. 5 is a schematic view illustrating the cathode fluid path and a cathode auxiliary fluid path in the electrolysis cell stack 10;

FIG. 6 is a schematic view explaining a structure example when a flow path plate 14 or a flow path plate 16 is viewed from the negative side of the Z axis in FIG. 4 and FIG. 5;

FIG. 7 is a schematic view explaining the structure example when the flow path plate 14 or the flow path plate 16 is viewed from the negative side of the Z axis in FIG. 4 and FIG. 5;

FIG. 8 is a schematic view illustrating another structure example of the electrolysis cell stack 10;

FIG. 9 is a view illustrating the anode fluid path and an anode auxiliary fluid path in the electrolysis cell stack 10;

FIG. 10 is a schematic view explaining a structure example when a flow path plate 15 or the flow path plate 16 is viewed from the positive side of the Z axis in FIG. 8 and FIG. 9;

FIG. 11 is a schematic view explaining the structure example when the flow path plate 15 or the flow path plate 16 is viewed from the positive side of the Z axis in FIG. 8 and FIG. 9;

FIG. 12 is a schematic view illustrating another configuration example of the electrochemical reaction device; and

FIG. 13 is a schematic view illustrating another configuration example of the electrochemical reaction device.

### DETAILED DESCRIPTION

An electrochemical reaction device of an embodiment includes: an electrolysis cell stack including: a pair of clamping plates; and a plurality of sub-stacks stacked between the pair of clamping plates, each of the plural sub-stacks including: a pair of support plates; a plurality of electrolysis cells stacked between the pair of support plates; and at least one fluid manifold completed within one of the plural sub-stacks; a measuring device configured to measure a physical quantity related to a state of at least one of the plural sub-stacks to acquire physical quantity data; and an information processing unit configured to process the physical quantity data from the measuring device. Each of the plural electrolysis cells includes: a cathode chamber; an anode chamber; a diaphragm provided between the cathode chamber and the anode chamber; a cathode arranged on the cathode chamber; and an anode arranged on the anode chamber. The pair of support plates includes at least four through holes including an inlet or an outlet of the at least one fluid manifold.

There will be explained an embodiment with reference to the drawings below. The relationship between the thickness of each component and its planar dimensions, the thickness ratio of each component, and so on illustrated in the drawings may differ from actual ones. Further, in the embodiment, substantially the same components are denoted by the same reference numerals and symbols, and explanations thereof are omitted as appropriate.

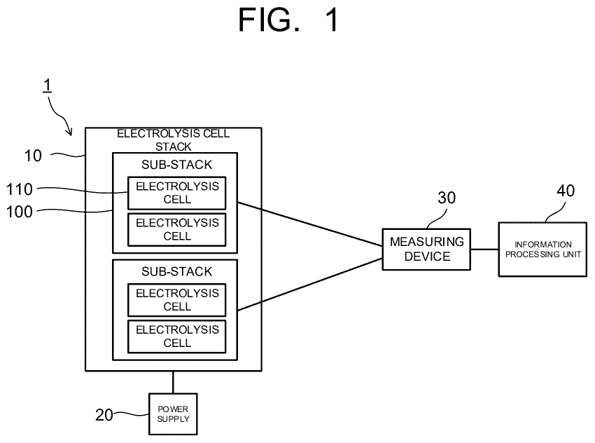

FIG. 1 is a schematic view illustrating a configuration example of an electrochemical reaction device in an embodiment. FIG. 1 illustrates an electrochemical reaction device 1. The electrochemical reaction device 1 includes an electrolysis cell stack (full stack) 10, a power supply 20, a measuring device 30, and an information processing unit 40.

The electrolysis cell stack 10 includes sub-stacks 100. FIG. 1 illustrates two sub-stacks 100, but the number of sub-stacks 100 is not limited in particular as long as it is two or more.

The sub-stack 100 includes electrolysis cells 110 that perform an electrochemical reaction. FIG. 1 illustrates an example where the sub-stack 100 includes two electrolysis cells 110, but the number of electrolysis cells 110 is not limited in particular.

The power supply 20 can supply power to the electrolysis cell stack 10, for example. The power supply 20 is connected to the electrolysis cell stack 10, for example.

The measuring device 30 can measure a physical quantity related to the state of the sub-stack 100, for example, to acquire physical quantity data. The measuring device 30 is connected to the sub-stacks 100, for example. The measuring device 30 includes, for example, at least one measuring instrument configured to measure at least one physical quantity.

The information processing unit 40 can process the physical quantity data obtained by the measuring device 30, for example. The information processing unit 40 is connected to the measuring device 30, for example.

The electrochemical reaction device 1 may include a plurality of electrolysis cell stacks 10. In this case, the power supply 20, the measuring device 30, and the information processing unit 40 may be provided for each electrolysis cell stack 10, or may be shared by the plural electrolysis cell stacks 10. The plural electrolysis cell stacks 10 may be electrically independent, or may be electrically connected in series or in parallel.

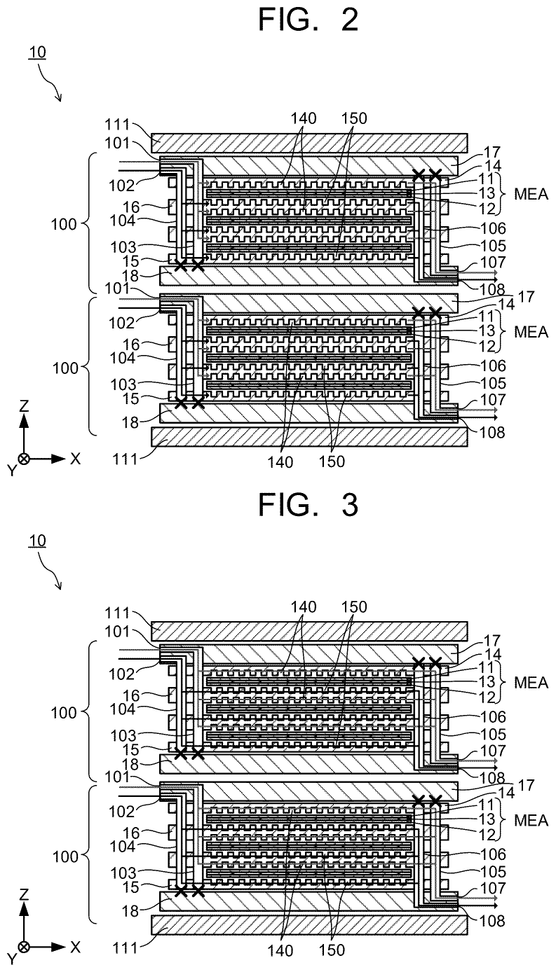

FIG. 2 is a schematic view illustrating a structure example of the electrolysis cell stack 10. FIG. 2 illustrates the X axis, the Y axis, and the Z axis. The X axis, the Y axis, and the Z axis intersect perpendicularly to one another. The Y axis is the direction toward the back of the paper sheet. The Z axis is the thickness direction of the electrolysis cell stack 10. FIG. 2 illustrates a portion of the X-Z cross section including the X axis and the Z axis.

The electrolysis cell stack 10 includes the sub-stacks 100 and clamping plates 111. The electrolysis cell stack 10 can be formed, for example, by clamping a stack of the plural sub-stacks 100 between the pair of clamping plates 111. FIG. 2 illustrates an example where two sub-stacks 100 and a pair of clamping plates 111 are provided, but the number of sub-stacks 100 is not particularly limited as long as it is two or more.

The sub-stack 100 includes a cathode 11, an anode 12, a diaphragm 13, a flow path plate 14 having a cathode flow path 140, a flow path plate 15 having an anode flow path 150, a flow path plate 16 having the cathode flow path 140 and the anode flow path 150, a support plate 17, and a support plate 18. The cathode 11, the diaphragm 13, and the anode 12 may be stacked to form a membrane electrode assembly MEA. A member such as a packing or gasket whose illustration is omitted may be provided as necessary at the outer edge of the membrane electrode assembly MEA, or between the membrane electrode assembly MEA and a member adjacent thereto. The cathode flow path 140 may form a cathode chamber. The anode flow path 150 may form an anode chamber. The cathode 11, the anode 12, the diaphragm 13, the cathode flow path 140, and the anode flow path 150 may form the electrolysis cell 110. FIG. 2 illustrates the sub-stack 100 including three electrolysis cells 110 sandwiched and supported by the support plates 17 and 18, but the number of electrolysis cells 110 provided in the sub-stack 100 is not particularly limited. Each of the plural electrolysis cells 110 may have a structure in which the cathode flow path 140 faces the cathode 11, the anode flow path 150 faces the anode 12, and the diaphragm 13 is provided between the cathode 11 and the anode 12.

The number of sub-stacks 100 in the electrolysis cell stack 10 is arbitrary, but it is, for example, 20 or less, for example, 10 or less, and for example, 5 or less. The number of electrolysis cells 110 in the sub-stack 100 is arbitrary, but it is, for example, 50 or less, for example, 20 or less, for example, 10 or less, and for example, 5 or less. By stacking the electrolysis cells 110 to form the sub-stack 100 and the electrolysis cell stack 10, the reaction amount of reducible material per unit area increases, and therefore the amount of reduction product produced can be increased.

In FIG. 2, the case where the members forming the electrolysis cell stack 10 are stacked in the Z-axis direction is explained, but the stacking direction is arbitrary. Therefore, they may be stacked in the X-axis or Y-axis direction, for example. The stacking direction may be vertical or horizontal. FIG. 2 illustrates the case where in each of the electrolysis cells 110, the cathode 11 is arranged above the anode 12 with the diaphragm 13 interposed therebetween, namely on the positive side of the Z axis, but the cathode 11 may also be arranged below the anode 12 with the diaphragm 13 interposed therebetween, namely, on the negative side of the Z axis. However, the positional relationship between the cathode 11 and the anode 12 needs to be the same in all the electrolysis cells 110. The same is true of the case where the stacking direction is the X-axis direction, the Y-axis direction, or any other arbitrary direction.

In FIG. 2, the members are illustrated separately for the sake of explanation, but in reality, the members are in contact with each other and are clamped together by the pair of clamping plates 111. Clamping can be performed using not-illustrated bolts or the like.

The cathode 11 is, for example, a reduction electrode for performing a reduction reaction of at least one reducible material (substance to be reduced) and producing a reduction product. The at least one reducible material contains carbon dioxide or nitrogen, for example. The cathode 11 reduces, for example, carbon dioxide to produce a carbon compound, or reduces nitrogen to produce a nitrogen compound such as ammonia. Examples of the carbon compound include carbon monoxide, formic acid, methanol, methane, ethanol, ethane, ethylene, formaldehyde, ethylene glycol, acetic acid, propanol, and so on. The cathode 11 may cause a side reaction of generating hydrogen through a reduction reaction of water as well as a reduction reaction of carbon dioxide or a reduction reaction of nitrogen.

The cathode 11 is arranged on a cathode chamber, for example. The cathode 11 has, for example, a cathode catalyst that promotes a reduction reaction that reduces at least one reducible material. The cathode catalyst can be formed using a material that reduces the activation energy for reducing at least one reducible material, for example. In other words, the cathode catalyst can be formed using a material that lowers the overvoltage when producing a reduction product by the reduction reaction of at least one reducible material, for example.

The cathode 11 may have a first surface in contact with the diaphragm 13 and a second surface facing the cathode flow path 140. Further, the cathode 11 may also include a gas diffusion layer and a cathode catalyst layer, for example. Between the gas diffusion layer and the cathode catalyst layer, the cathode 11 may also include a porous layer that is denser than the gas diffusion layer. The gas diffusion layer is arranged on the cathode flow path 140 side, and the cathode catalyst layer is arranged on the diaphragm 13 side. The cathode catalyst layer may enter the gas diffusion layer. The cathode catalyst layer preferably has catalyst nanoparticles, a catalyst nanostructure, or the like. The gas diffusion layer is formed of, for example, carbon paper, carbon cloth, or the like, and has been subjected to a water repellent treatment. An electrolytic solution or ions are supplied to the cathode catalyst layer from the anode 12 side via the diaphragm 13. In the gas diffusion layer, a cathode supply fluid is supplied from the cathode flow path 140, and products of the reduction reaction are discharged. The reduction reaction occurs near the boundary between the gas diffusion layer and the cathode catalyst layer, and gaseous products are discharged from the cathode flow path 140 to the outside of the electrolysis cell 110 through the gas diffusion layer.

Examples of the cathode catalyst include metals such as gold (Au), silver (Ag), copper (Cu), platinum (Pt), palladium (Pd), nickel (Ni), cobalt (Co), iron (Fe), manganese (Mn), titanium (Ti), cadmium (Cd), zinc (Zn), indium (In), gallium (Ga), lead (Pb), and tin (Sn), metal materials such as alloys containing at least one of these metals and intermetallic compounds, carbon materials such as carbon (C), graphene, CNT (carbon nanotube), fullerene, and ketjen black, and metal complexes such as a Ru complex and a Re complex. The cathode catalyst layer can employ various shapes such as a plate shape, a mesh shape, a wire shape, a particle shape, a porous shape, a thin film shape, and an island shape.

The anode 12 is arranged on an anode chamber, for example. The anode 12 is an oxidation electrode for performing an oxidation reaction of at least one oxidizable material (substance to be oxidized) and thereby producing an oxidation product, for example. The at least one oxidizable material contains water, for example. The anode 12 oxidizes an oxidizable material such as substances or ions in an electrolytic solution (anode solution), for example, to produce an oxidation product. Examples of the oxidation product include oxygen.

The anode 12 may have a first surface in contact with the diaphragm 13 and a second surface facing the anode flow path 150. The anode 12 has an anode catalyst that promotes an oxidation reaction that oxidizes water to produce oxygen, for example. The anode catalyst can be formed using a material that reduces the activation energy when oxidizing an oxidizable material, in other words, a material that lowers the reaction overpotential, for example. Examples of the oxidation reaction at the anode 12 include reactions of oxidizing water to produce oxygen or a hydrogen peroxide solution, oxidizing chloride ions (Cl⁻) to produce chlorine, oxidizing carbonate ions or hydrogen carbonate ions to produce carbon dioxide, and so on.

Examples of the anode catalyst include metals such as platinum (Pt), palladium (Pd), iridium (ir), and nickel (Ni), alloys containing these metals, intermetallic compounds, binary metal oxides such as manganese oxide (Mn—O), iridium oxide (Ir—O), nickel oxide (Ni—O), cobalt oxide (Co—O), iron oxide (Fe—O), tin oxide (Sn—O), indium oxide (In—O), ruthenium oxide (Ru—O), lithium oxide (Li—O), and lanthanum oxide (La—O), ternary metal oxides such as Ni—Co—O, Ni—Fe—O, La—Co—O, Ni—La—O, Sr—Fe—O, and Ru—Co—O, quaternary metal oxides such as Pb—Ru—Ir—O, La—Sr—Co—O, and Ru—Co—Sn—O, and metal complexes such as a Ru complex and a Fe complex.

The anode 12 may include a base material having a structure capable of making an anode supply fluid or ions move between the diaphragm 13 and the anode flow path 150, which is, for example, a porous structure such as a mesh material, a punching material, a porous body, or a metal fiber sintered body. The base material may be formed of a metal such as titanium (Ti), nickel (Ni), or iron (Fe), or a metal material such as an alloy containing at least one of these metals (for example, SUS), or may be formed of the above-described anode catalyst. When an oxide is used as the anode catalyst, it is preferable to form a catalyst layer by attaching or stacking the anode catalyst to or on the surface of the base material formed of the above-described metal material. The anode catalyst may have nanoparticles, a nanostructure, a nanowire, or the like for increasing the oxidation reaction. The nanostructure is a structure with nanoscale irregularities formed on the surface of the catalyst material.

The diaphragm 13 is provided between the cathode 11 and the anode 12. The diaphragm 13 can separate the cathode chamber and the anode chamber. The diaphragm 13 can make ions such as hydrogen ions (H⁺), hydroxide ions (OH⁻), hydrogen carbonate ions (HCO₃⁻), and carbonate ions (CO₃²⁻) move. By the diaphragm 13, the electrolysis cell 110 having a two-chamber structure can be formed. The diaphragm 13 may be provided in contact with the cathode 11 and the anode 12.

The diaphragm 13 is formed of an ion exchange membrane capable of making ions and an electrolytic solution move between the cathode 11 and the anode 12 and separating the cathode flow path 140 and the anode flow path 150, or the like. Examples of the ion exchange membrane include NEOSEPTA (registered trademark) of ASTOM Corporation, Selemion (registered trademark) of AGC Inc., Aciplex (registered trademark) of Asahi Kasei Corp., Fumasep (registered trademark), fumapem (registered trademark) of Fumatech GmbH, Nafion (registered trademark) being fluorocarbon resin made by sulfonating and polymerizing tetrafluoroethylene of E.I. du Pont de Nemours and Company, Lewabrane (registered trademark) of LANXESS AG, IONSEP (registered trademark) of IONTECH Inc., Mustang (registered trademark) of PALL Corporation, RALEX (registered trademark) of mega Corporation, Gore-Tex (registered trademark) of Gore-Tex Co., and so on. However, besides the ion exchange membrane, a glass filter, a porous polymer membrane, a porous insulating material, or the like may be applied to the diaphragm 13 as long as the material is capable of making ions move between the anode 12 and the cathode 11.

Besides the ion exchange membrane, it is possible to use porous membranes of a silicone resin, fluorine-based resins (perfluoroalkoxyalkane (PFA), perfluoroethylene propene copolymer (FEP), polytetrafluoroethylene (PTFE), ethylene-tetrafluoroethylene copolymer (ETFE), polyvinylidene fluoride (PVDF), polychlorotrifluoroethylene (PCTFE), ethylene-chlorotrifluoroethylene copolymer (ECTFE), and so on), polyethersulfone (PES), and ceramics, packing filled with glass filter, agar, and so on, insulating porous bodies of zeolite, oxide, and so on, and so on, for example. In particular, a hydrophilic porous membrane is preferable as the diaphragm 13 because it can inhibit clogging due to air bubbles.

The cathode flow path 140 is provided facing the cathode 11, for example. The cathode flow path 140 has an inlet for supplying a cathode supply fluid and an outlet for discharging a cathode discharge fluid.

The cathode supply fluid is, for example, a cathode supply gas or a two-phase flow of a cathode supply gas and a cathode supply liquid (gas-liquid two-phase flow). The cathode supply gas contains at least one gas of carbon dioxide, nitrogen, argon, and water vapor, for example. The cathode supply gas may also be a mixed gas of at least two gases selected from carbon dioxide, nitrogen, argon, and water vapor. The cathode supply liquid contains water, for example.

The cathode supply fluid changes its composition as it passes through the cathode flow path 140 and is then discharged to the outside of the cathode flow path 140. The fluid discharged from the cathode flow path 140 is referred to as the cathode discharge fluid. The cathode discharge fluid contains a target product, which is separated and recovered as necessary. The cathode discharge fluid may be subjected to gas-liquid separation to make a portion of the gas phase flow together into the cathode supply fluid. This method is effective for increasing the conversion ratio of reactants in the cathode supply fluid. Further, the cathode discharge fluid can be subjected to gas-liquid separation to make a portion or all of the liquid phase flow together into the anode supply fluid.

The cathode supply fluid is prepared by a cathode supply part, for example, and is supplied to the electrolysis cell stack 10. The cathode supply part may include a humidifier. The cathode supply part may also include a bypass pipe that allows fluid to flow by bypassing the humidifier when it is not in use. A cathode supply fluid supply system including the cathode supply part may include a gas cylinder, a flow rate control part, a pressure control part, and so on.

The humidifier can humidify the cathode supply fluid supplied from a cathode supply fluid supply source, such as a gas cylinder, for example. The cathode supply fluid is preferably only the gas phase at the previous stage of the humidifier. The humidifier can mix water vapor into the cathode supply fluid supplied from the previous stage of the humidifier. Examples of the method of humidification by the humidifier include methods such as a method of performing gas bubbling in liquid water, a method of providing a vaporizer in a gas flow path to pour liquid water into the vaporizer and evaporate it, and a method of spraying liquid water in gas and evaporating it, but the method is not limited to these methods.

The humidifier is preferably able to regulate the amount of water vapor to be mixed into the cathode supply fluid supplied from the previous stage of the humidifier. Examples of the method of regulating the amount of water vapor include methods such as a method of specifying the temperature of liquid water to be used for bubbling, a method of specifying the total amount or the rate of liquid water to be poured into a vaporizer, and a method of specifying the total amount or the rate of liquid water to be discharged from a sprayer, but the method is not limited to these methods. The humidified cathode supply fluid to be discharged from the humidifier is preferably only the gas phase, but may contain a liquid phase.

The anode flow path 150 is provided facing the anode 12, for example. The anode flow path 150 has an inlet for supplying an anode supply fluid and an outlet for discharging an anode discharge fluid.

The anode supply fluid contains water, for example. The form of water present may be liquid water or water vapor. In particular, when the anode supply fluid contains no gas phase and is only the liquid phase, this is also referred to as an anode aqueous solution below. Examples of the anode aqueous solution include aqueous solutions containing any electrolyte. Examples of the electrolyte-containing aqueous solution include an aqueous solution containing at least one selected from hydroxide ions (OH⁻), hydrogen ions (H⁺), potassium ions (K⁺), sodium ions (Na⁺), lithium ions (Li⁺), chloride ions (Cl⁻), bromide ions (Br⁻), iodide ions (I⁻), nitrate ions (NO₃⁻), sulfate ions (SO₄²⁻), phosphate ions (PO₄²⁻), borate ions (BO₃³⁻), carbonate ions (CO₃²⁻), and hydrogen carbonate ions (HCO₃⁻). In order to reduce the electrical resistance of the solution, an alkali solution in which an electrolyte such as potassium hydroxide or sodium hydroxide is dissolved with a high concentration may be used as the anode aqueous solution.

The anode supply fluid changes its composition as it passes through the anode flow path 150 and is then discharged to the outside of the anode flow path 150. The fluid discharged from the anode flow path 150 is referred to as the anode discharge fluid. The anode discharge fluid contains gases such as oxygen generated at the anode 12. The anode discharge fluid may be subjected to gas-liquid separation to make a portion or all of the liquid phase flow together into the anode supply fluid. The anode supply fluid can be circulated by treating the liquid phase portion of the anode discharge fluid as the anode supply fluid and supplying it to the anode flow path 150 without supplying the anode supply fluid from outside the system.

The anode supply fluid is supplied to the electrolysis cell stack 10 via an anode supply part. When the anode supply fluid is the anode aqueous solution, for example, an anode supply fluid supply system including the anode supply part includes devices such as a pressure control part, an anode aqueous solution tank, a flow rate control part (pump), a reference electrode, a pressure gauge, and a temperature regulating component. The anode aqueous solution is supplied to the anode flow path 150 with its flow rate, pressure, and temperature controlled in the anode supply fluid supply system.

The flow path plate 14 is a sub-stack end flow path plate provided at one end of the sub-stack 100. The flow path plate 14 forms the cathode flow path 140 of the electrolysis cell 110 at the first end of the sub-stack 100, for example. The cathode flow path 140 is provided on the surface of the flow path plate 14 facing the cathode 11.

The flow path plate 15 is a sub-stack end flow path plate provided at the other end of the sub-stack 100. The flow path plate 15 forms the anode flow path 150 of the electrolysis cell 110 at the second end of the sub-stack 100, for example. The anode flow path 150 is provided on the surface of the flow path plate 15 facing the anode 12.

The flow path plate 16 is a sub-stack flow path plate made of a bipolar plate having the cathode flow path 140 and the anode flow path 150, for example. The flow path plate 16 is provided between the plural membrane electrode assemblies MEA and separates the plural electrolysis cells 110. The cathode 11 and the anode 12 that are adjacent to each other may be electrically connected via the flow path plate 16. The cathode flow path 140 of the flow path plate 16 is provided, for example, on a first surface of the bipolar plate and faces the cathode 11 of one of the plural membrane electrode assemblies MEA. The anode flow path 150 of the flow path plate 16 is provided, for example, on a second surface opposite to the first surface of the bipolar plate and faces the anode 12 of the other of the plural membrane electrode assemblies MEA.

FIG. 2 illustrates the case where the flow path plate 16 is a bipolar plate, but the flow path plate 16 may also be formed of two monopolar plates. In other words, the above-described bipolar plate may be divided into two plates by a plane parallel to the X-Y plane. In this case, the flow path plate 16 is composed of a first monopolar plate that faces the cathode 11 of one of the plural membrane electrode assemblies MEA and forms a cathode flow path, and a second monopolar plate that faces the anode 12 of the other of the plural membrane electrode assemblies MEA and forms an anode flow path. The first monopolar plate and the second monopolar plate may be electrically connected.

At least one of the flow path plate 14, the flow path plate 15, and the plural flow path plates 16 to be provided according to the number of electrolysis cells 110 preferably has lands (projections). The lands are provided for mechanical retention and electrical conduction. The lands are provided in contact with the cathode 11 or the anode 12. The lands are preferably provided alternately so as to uniformize the flow of fluid. These lands allow the cathode flow path 140 or the anode flow path 150 to have a meandering shape along the surface.

The flow path plate 14, the flow path plate 15, and the flow path plate 16 are preferably formed by using a material having low chemical reactivity and high conductivity. Examples of such a material include metal materials such as Ti and SUS, carbon materials, and so on. Further, a member such as a packing whose illustration is omitted may be sandwiched between each flow path plate and a member adjacent thereto as necessary.

The support plate 17 is a sub-stack end support plate provided at one end of the sub-stack 100. The support plate 17 is in contact with the flow path plate 14 and is provided on the opposite side of the flow path plate 14 from the membrane electrode assembly MEA. The support plate 18 is a sub-stack end support plate provided at the other end of the sub-stack 100. The support plate 18 is in contact with the flow path plate 15 and is provided on the opposite side of the flow path plate 15 from the membrane electrode assembly MEA. The support plate 17 and the support plate 18 are paired to form an outer edge portion of the sub-stack 100.

The support plates 17 and 18 may have a component for clamping the sub-stack 100 between the support plate 17 and the support plate 18. Examples of the clamping component include a component that attaches not-illustrated bolts and nuts to the support plates 17 and 18 to clamp them, a component that attaches not-illustrated actuators to the support plates 17 and 18 to reduce the distance between the support plates 17 and 18, and so on, but the clamping component is not limited to these. It is preferable that the parts required for clamping should be installed so as not to interfere with the support plate 17 or 18 of other adjacent sub-stacks 100. For example, recessed portions may be provided in the support plates 17 and 18 to be clamped, and/or in the support plates 17 and 18 of other adjacent sub-stacks 100 so that tip portions of the bolts and the nuts used for clamping can be accommodated in the recessed portions. For example, the actuators may be attached to the support plates 17 and 18 from the side surfaces thereof and arranged so as not to come into contact with the adjacent sub-stacks 100.

It is preferable that the support plate 17 and the support plate 18 each should be thicker than the flow path plate 14, the flow path plate 15, and the flow path plate 16. Typically, the flow path plate 14, the flow path plate 15, and the flow path plate 16 are formed thin to reduce the thickness or weight when stacked. For this reason, the support plates 17 and 18 having a certain thickness or rigidity make it possible to expect the effect of facilitating handling of the sub-stack 100. The thickness of the support plates 17 and 18 is, for example, 2 mm or more, for example, 5 mm or more, and for example, 1 cm or more. Handles or protrusions may be attached to the support plates 17 and 18. The handles or protrusions may be installed on the side surfaces of the support plates 17 and 18. The protrusions are expected to have the effect of facilitating work when handling the entire sub-stack 100 or the support plates 17 and 18 with a transport device such as a lifter, for example.

The support plate 17 may be formed integrally with the flow path plate 14. The support plate 18 may be formed integrally with the flow path plate 15.

The support plate 18 may be molded to fit with the support plate 17 of another adjacent sub-stack 100. A member such as a packing whose illustration is omitted may be sandwiched between the support plate 17 and a member adjacent thereto and between the support plate 18 and a member adjacent thereto as necessary.

The support plate 18 can be separated from the support plate 17 of another adjacent sub-stack 100. This allows each of the sub-stacks 100 to be handled independently, facilitating operations such as assembling, removing, transporting, replacing, and exchanging positions of the sub-stacks 100.

### First Electrical Connection Example

There will be explained the case where power supply to the electrolysis cell stack 10 illustrated in FIG. 2 is performed on the entire electrolysis cell stack 10 collectively below. In this case, the respective sub-stacks 100 are electrically connected.

The support plate 18 may be electrically connected to the support plate 17 of another adjacent sub-stack 100. The support plate 17 may be electrically connected to the adjacent flow path plate 14, and the support plate 18 may be electrically connected to the adjacent flow path plate 15 respectively. Therefore, it is preferable that portions of the support plate 17 and the support plate 18 should be formed of a conductive material. It is more preferable that the regions of the support plate 17 and the support plate 18 that overlap with the region of the membrane electrode assembly MEA where an electrode reaction occurs should be formed of a conductive material. The support plate 17 and the support plate 18, which are paired in the same sub-stack 100, are not electrically connected preferably. Therefore, when the support plate 17 and the support plate 18 have a component for clamping the sub-stack 100 between them, it is preferable that portions of the support plate 17 and the support plate 18, or a portion of the member used in the clamping component should be formed of an insulator.

The clamping plates 111 in a pair are electrolysis cell stack clamping plates located on the outer edge of the electrolysis cell stack 10, sandwiching the plural sub-stacks 100 therebetween. The clamping plates 111 may be formed of an insulator. Further, regardless of the conductivity of the clamping plate 111, a not-illustrated insulating plate may be provided between the clamping plate 111 and the support plate 17 and between the clamping plate 111 and the support plate 18. The clamping plates 111 preferably have high rigidity. Having high rigidity increases the in-plane uniformity of clamping pressure when clamping the plural sub-stacks 100, making it possible to prevent unintended fluid flow inside the electrolysis cell stack 10 and increase the uniformity of a reaction field. Even when the support plates 17 and 18 have a component for clamping each individual sub-stack 100, it is preferable that the clamping plates 111 in a pair should have a clamping force equal to or greater than a certain level. This makes it possible to increase the adhesion between the sub-stacks 100 and reduce the electrical resistance between the sub-stacks 100.

The electrolysis cell stack 10 may include a first current collector and a second current collector that are not illustrated. The first current collector is stacked between the clamping plate 111 and the adjacent support plate 17, for example. The second current collector is stacked between the other clamping plate 111 and the adjacent support plate 18, for example. The first current collector may be electrically connected to the flow path plate 14 via the support plate 17 of the adjacent sub-stack 100. The second current collector may be electrically connected to the flow path plate 15 via the support plate 18 of the adjacent sub-stack 100. The first current collector and the second current collector are electrically connected to the power supply via wiring or the like, for example. The first current collector and the second current collector are preferably formed using a highly conductive material. Portions of the first current collector and the second current collector may be formed as a busbar. The busbar may be provided in the X-Y plane so as to protrude laterally relative to the stacking of the electrolysis cell stack 10, or a hole penetrating in the Z-axis direction may be provided in the clamping plates 111 and the busbar may be provided so as to protrude perpendicularly to the stacking direction of the electrolysis cell stack 10 through the hole.

### Second Electrical Connection Example

There will be explained the case where the power supply to the electrolysis cell stack 10 illustrated in FIG. 2 is performed for each sub-stack 100 below. In this case, the respective sub-stacks 100 are not electrically connected.

The support plate 18 is not electrically connected to the support plate 17 of another adjacent sub-stack 100. Therefore, the portions of the support plate 17 and the support plate 18 that are in contact with at least the adjacent sub-stack 100 or the clamping plate 111 are preferably formed of an insulating material. The support plate 17 and the support plate 18 may be or do not have to be electrically connected to the adjacent flow path plates 14 and 15. The support plate 17 and the support plate 18 may be formed of a highly fire-resistant or heat-resistant material. Due to having high fire resistance or heat resistance, even if a local temperature rise occurs inside the sub-stack 100 because of factors such as an electrical short, or a member burns, the effect of the above can be confined only within the sub-stack 100. Therefore, as long as the affected sub-stack 100 is repaired or replaced, it is possible to resume operation of the electrolysis cell stack 10 without making any changes to the other sub-stacks 100, thereby reducing labor hours or costs. It is preferable that the support plate 17 and the support plate 18, which are paired in the same sub-stack 100, should not be electrically connected. Therefore, when the support plate 17 and the support plate 18 have a component for clamping the sub-stack 100 therebetween, it is preferable that portions of the support plate 17 and the support plate 18 or a portion of the member used in the clamping component should be formed of an insulator. The clamping plates 111 may also be formed of an insulator.

When current and voltage application is performed on each sub-stack 100, each of the sub-stacks 100 may include a third current collector and a fourth current collector that are not illustrated. The third current collector is stacked between the support plate 17 and the adjacent flow path plate 14, for example. The fourth current collector is stacked between the support plate 18 and the adjacent flow path plate 15, for example. The third current collector and the fourth current collector are electrically connected to the power supply 20 via wiring or the like, for example. The third current collector and the fourth current collector are preferably formed using a highly conductive material. Portions of the third current collector and the fourth current collector may be formed as a busbar. The busbar may be provided in the X-Y plane so as to protrude laterally relative to the stacking of the electrolysis cell stack 10. In place of providing the third current collector and the fourth current collector, portions of the flow path plate 14 and the flow path plate 15 made of an electrically conductive material may be formed as the busbar. Further, portions of the support plate 17 and the support plate 18 may be formed of a conductive material to form the busbars, which are electrically connected to the flow path plate 14 and the flow path plate 15. These busbars are electrically connected to the power supply 20 via wiring or the like.

When current and voltage application is performed on each sub-stack 100, it is possible to stop power supply from the power supply 20 to some of the sub-stacks 100 while continuing power supply to the other sub-stacks 100 during operation of the electrochemical reaction device 1. In this case, only the sub-stacks 100 whose power supply has been stopped may be repaired or replaced while continuing the operation as the device.

The support plate 17 and the support plate 18 have at least four through holes for fluid. In other words, the total number of through holes for fluid provided in the support plate 17 and the support plate 18 included in one sub-stack 100 is four or more. FIG. 2 illustrates two through holes in the support plate 17 that form a cathode fluid inlet 101 and an anode fluid inlet 102, and illustrates two through holes in the support plate 18 that form a cathode fluid outlet 107 and an anode fluid outlet 108, which illustrates four through holes in total. Each of these through holes is provided so that one end thereof is located at the side surface of the support plate 17 or the support plate 18 and the other end thereof is located at the surface of the support plate 17 or the support plate 18 that is in contact with the flow path plate 14 or the flow path plate 15.

The two through holes in the support plate 17 are connected to two through holes provided to pass through the adjacent flow path plate 14 in the Z-axis direction, and are further connected to through holes provided in the flow path plate 16 and the flow path plate 15 to form a fluid manifold 103 (cathode inlet manifold) and a fluid manifold 104 (anode inlet manifold). The cathode fluid inlet 101 of the fluid manifold 103 is connected to the inlet of the cathode flow path 140. The anode fluid inlet 102 of the fluid manifold 104 is connected to the inlet of the anode flow path 150. The through holes in the flow path plate 15 that form the fluid manifold 103 and the fluid manifold 104 are closed at the end on the negative side of the Z axis in FIG. 2. The closure may be performed using a not-illustrated packing or gasket. The ends of the through holes provided at the side surface of the support plate 17 function as the end of the cathode fluid inlet 101 and the end of the anode fluid inlet 102.

A connecting flow path is provided between the fluid manifold 103 and the cathode flow path 140 of each of the electrolysis cells 110, and a flow parallel to the X-Y plane is formed. This allows the cathode supply fluid to be supplied to the cathode flow paths 140 of the respective electrolysis cells 110. The connecting flow path may be formed by machining a portion of the flow path plate 14 or the flow path plate 16. Similarly, a connecting flow path is provided between the fluid manifold 104 and the anode flow path 150 of each of the electrolysis cells 110, and a flow parallel to the X-Y plane is formed. This allows the anode supply fluid to be supplied to the anode flow paths 150 of the respective electrolysis cells 110. The connecting flow path may be formed by machining a portion of the flow path plate 15 or the flow path plate 16.

The other through holes provided in the flow path plates 14, 15, and 16, and the support plates 17 and 18 are connected to each other to form a fluid manifold 105 (cathode outlet manifold) and a fluid manifold 106 (anode outlet manifold). The cathode fluid outlet 107 of the fluid manifold 105 is connected to the outlet of the cathode flow path 140. The anode fluid outlet 108 of the fluid manifold 106 is connected to the outlet of the anode flow path 150. The ends of the through holes on the positive side of the Z axis provided in the flow path plate 14 are closed. The ends of the through holes at the side surface of the support plate 18 function as the end of the cathode fluid outlet 107 and the end of the anode fluid outlet 108. A connecting flow path is provided between the fluid manifold 105 and the cathode flow path 140 of each of the electrolysis cells 110, and a flow parallel to the X-Y plane is formed. This allows the cathode discharge fluids to be discharged from the cathode flow paths 140 of the respective electrolysis cells 110 to the fluid manifold 105. The connecting flow path may be formed by machining a portion of the flow path plate 14 or the flow path plate 16. A connecting flow path is provided between the fluid manifold 106 and the anode flow path 150 of each of the electrolysis cells 110, and a flow parallel to the X-Y plane is formed. This allows the anode discharge fluids to be discharged from the anode flow paths 150 of the respective electrolysis cells 110 to the fluid manifold 106. The connecting flow path may be formed by machining a portion of the flow path plate 15 or the flow path plate 16.

FIG. 2 illustrates the case where the cathode supply fluid and the anode supply fluid flow in the fluid manifold 103 and the fluid manifold 104 in the positive to negative direction of the Z axis, but these fluids may also flow in the negative to positive direction of the Z axis. In this case, the cathode fluid inlet 101 and/or the anode fluid inlet 102 may be provided in the support plate 18. FIG. 2 illustrates the case where the cathode discharge fluid and the anode discharge fluid flow in the fluid manifold 105 and the fluid manifold 106 in the positive to negative direction of the Z axis, but these fluids may also flow in the negative to positive direction of the Z axis. In this case, the cathode fluid outlet 107 and/or the anode fluid outlet 108 may be provided in the support plate 17.

The through holes in the flow path plates 14 and 15 that are closed in FIG. 2 are not required as long as they are used in the configuration illustrated in FIG. 2, but it is preferable that they should be formed in advance because there may be cases during later-described maintenance, where the positions or orientations of the members are changed to reassemble the sub-stack 100 and the electrolysis cell stack 10.

The electrochemical reaction device 1 may include a guide component so as to prevent displacement of the positions of the members within the X-Y plane when the electrolysis cell stack 10 is disassembled and reassembled. Examples of the guide component include jigs that hold the electrolysis cell stack 10 from the outside, and guide pins that penetrate members of the electrolysis cell stack 10 in the stacking direction. When the guide pins are used, holes for the guide pins to pass through may be provided in the members, and it is preferable that these holes should not interfere with the fluid paths from the perspective of preventing liquid or gas leakage.

FIG. 3 is a view illustrating the cathode fluid path and the anode fluid path in the electrolysis cell stack 10 illustrated in FIG. 2. The fluid manifold 103 and the fluid manifold 104 are independent for each sub-stack 100. In other words, the fluid manifold 103 and the fluid manifold 104 are completed within the sub-stack 100. Similarly, the fluid manifold 105 and the fluid manifold 106 are also completed within the sub-stack 100. Being completed within the sub-stack 100 means that the corresponding fluid manifold extends only within one sub-stack 100 and does not extend outside the one sub-stack 100, for example, does not extend into the inside of another adjacent sub-stack 100.

The fluid manifold 103 and the fluid manifold 104 are completed within the sub-stack 100, and thereby the flow rate, dew point, composition, and the like of the supply fluid can be regulated for each sub-stack 100. Further, the fluid manifold 103 and the fluid manifold 104 completed within the sub-stack 100 can also be used for a refresh operation of the sub-stack 100.

When the cathode supply fluid contains the reducible material, it is important to accurately distribute and supply a predetermined amount of cathode supply fluid to the respective electrolysis cells 110 in the electrolysis cell stack 10, to thereby control the reduction reaction of the reducible material that occurs in each electrolysis cell 110. Examples of the case where the cathode supply fluid contains the reducible material include carbon dioxide electrolysis and nitrogen electrolysis. As long as the fluid manifold 103 is independent for each of the sub-stacks 100, the flow rate of the cathode supply fluid can be regulated for each sub-stack 100 using a mass flow controller or the like. In this case, regarding the fluid distribution to each of the electrolysis cells 110, only the fluid distribution within one sub-stack 100 needs to be considered. If the fluid manifold 103 is connected to the plural sub-stacks 100, it is necessary to consider the fluid distribution to all of the electrolysis cells 110 included in the plural sub-stacks 100. However, it is not easy to achieve a predetermined fluid distribution through the structural design of the manifold or the connecting flow path. Including the fluid manifolds 103 that are completed for each sub-stack 100 makes it possible to expect the effect of making fluid distribution management easier.

The refresh operation can be performed in order to restore performance when the performance of the electrolysis cell stack 10 including the plural sub-stacks 100 deteriorates, and can also be performed in order to prevent the performance of the electrolysis cell stack 10 from deteriorating. Examples of the refresh operation include current and voltage-related operations such as reducing a current density, setting a current density to zero, applying a reverse current, reducing a potential difference between ends of the electrolysis cell stack 10 or the sub-stack 100, setting a potential difference to zero, and reversing a potential. Further, other examples of the refresh operation include fluid-related operations such as increasing the flow rate of the cathode supply fluid, raising the dew point of the cathode supply fluid, supplying a rinse solution into the cathode flow path 140, and drying the cathode flow path 140. These operations may be performed in combination. In the embodiment illustrated in FIG. 3, the fluid-related operations can be performed for each sub-stack 100. Performing the refresh operation for each sub-stack 100 is more efficient than performing the refresh operation for the entire electrolysis cell stack 10. For example, supplying a rinse solution through the sub-stack 100 that requires no refresh operation inherently may actually cause a decrease in performance. The embodiment illustrated in FIG. 3 can avoid such a situation.

The fluid manifold 105 and the fluid manifold 106 that are completed within the sub-stack 100 are provided, and thereby it is also possible to separately collect the outlet fluid for each sub-stack 100. This allows the values of performance indices such as product selectivity and Faraday efficiency to be obtained for each sub-stack 100. The values of product selectivity and Faraday efficiency for each sub-stack 100 can be utilized for diagnosing the deterioration state of the sub-stack 100, predicting its lifetime, formulating a maintenance plan, and so on, and are expected to contribute to improving accuracy of the deterioration state diagnosis, lifetime prediction, and maintenance plan formulation.

The cathode supply fluid and the anode supply fluid, which are supplied to the respective sub-stacks 100, can be distributed to the respective sub-stacks 100 from pipes outside the electrolysis cell stack 10 that are fewer in number than the number of sub-stacks 100. Examples of the method of distribution include a method of providing a dedicated pump or mass flow controller for each sub-stack 100 to control the flow rate of the supply fluid, a method of providing a manifold outside the electrolysis cell stack 10 to distribute the fluid, and so on, but the method is not limited to these. Further, the cathode discharge fluids and the anode discharge fluids, which are discharged from the respective sub-stacks 100, can be combined into pipes that are fewer in number than the number of sub-stacks 100.

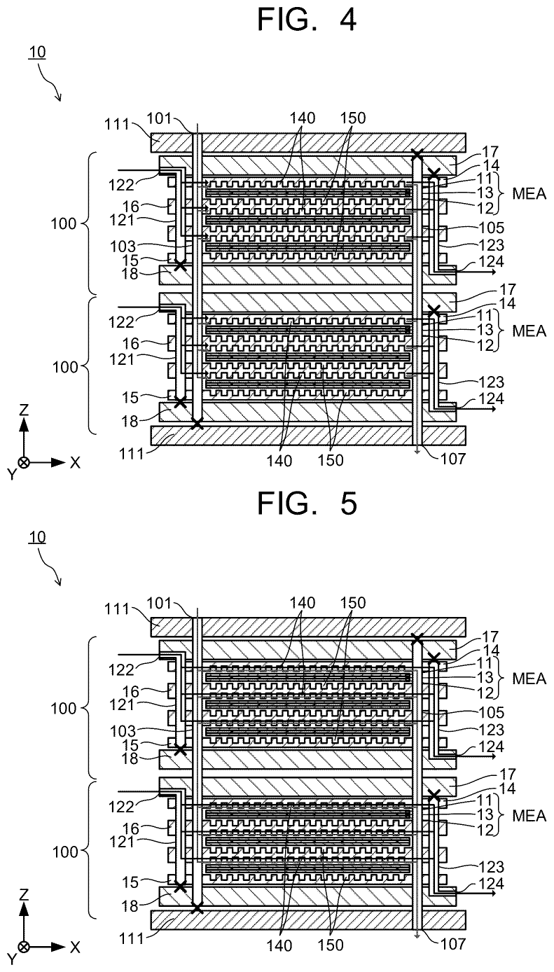

FIG. 4 is a schematic view illustrating another structure example of the electrolysis cell stack 10 of the electrochemical reaction device 1. FIG. 5 is a schematic view illustrating the cathode fluid path and a cathode auxiliary fluid path in the electrolysis cell stack 10 illustrated in FIG. 4. For ease of viewing, the fluid paths related to the anode 12 are not illustrated in FIG. 4 and FIG. 5.

FIG. 4 illustrates three through holes in each of the support plates 17 and 18. Two of them are through holes in the Z-axis direction that form the cathode fluid inlet 101 and the cathode fluid outlet 107 in FIG. 4, and are connected to the through holes in the Z-axis direction provided in the flow path plate 14, the flow path plate 15, and the flow path plate 16 to form the fluid manifold 103 and the fluid manifold 105. The fluid manifold 103 is connected to a through hole in the Z-axis direction provided in the upper clamping plate 111 in FIG. 4, and this portion functions as the end of the cathode fluid inlet 101. The lower end of the fluid manifold 103 is closed. The closure may be performed using a not-illustrated packing or gasket. The fluid manifold 105 is connected to a through hole in the Z-axis direction provided in the lower clamping plate 111 in FIG. 4, and this portion functions as the end of the cathode fluid outlet 107. The upper end of the fluid manifold 105 is closed. The closure may be performed using a not-illustrated packing or gasket.

The fluid manifold 103 passes through the entire electrolysis cell stack 10 and supplies the cathode supply fluid to the electrolysis cells 110 of all the sub-stacks 100. A connecting flow path is provided between the fluid manifold 103 and the cathode flow path 140 of each of the electrolysis cells 110, and a flow parallel to the X-Y plane is formed. This allows the cathode supply fluid to be supplied to the cathode flow paths 140 of the respective electrolysis cells 110. The connecting flow path may be formed by machining a portion of the flow path plate 14 or the flow path plate 16.

The fluid manifold 105 passes through the entire electrolysis cell stack 10 and forms a path for the cathode discharge fluids discharged from the electrolysis cells 110 of all the sub-stacks 100. A connecting flow path is provided between the fluid manifold 105 and the cathode flow path 140 of each of the electrolysis cells 110, and a flow parallel to the X-Y plane is formed. This allows the cathode discharge fluids to be discharged from the cathode flow paths 140 of the respective electrolysis cells 110 to the fluid manifold 105. The connecting flow path may be formed by machining a portion of the flow path plate 14 or the flow path plate 16.

The remaining one of the three through holes provided in the support plate 17 is a through hole that forms a cathode auxiliary fluid inlet 122, with one end of the through hole provided at the surface of the support plate 17 that is in contact with the flow path plate 14 and the other end thereof provided at the side surface of the support plate 17. This through hole is connected to a through hole provided to pass through the adjacent flow path plate 14 in the Z-axis direction, and is further connected to through holes provided in the flow path plate 16 and the flow path plate 15, thereby forming an auxiliary manifold 121 (cathode inlet auxiliary manifold). The cathode auxiliary fluid inlet 122 of the auxiliary manifold 121 is connected to the inlet of the cathode flow path 140. The through hole in the flow path plate 15 that forms the auxiliary manifold 121 is closed at the end on the negative side of the Z axis in FIG. 4. The closure may be performed using a not-illustrated packing or gasket. The end of the through hole provided at the side surface of the support plate 17 functions as the end of the cathode auxiliary fluid inlet 122.

The remaining one of the three through holes provided in the support plate 18 is a through hole that forms a cathode auxiliary fluid outlet 124, with one end of the through hole provided at the surface of the support plate 18 that is in contact with the flow path plate 15 and the other end thereof provided at the side surface of the support plate 18. This through hole is connected to a through hole provided to pass through the adjacent flow path plate 15 in the Z-axis direction, and is further connected to through holes provided in the flow path plate 16 and the flow path plate 14, thereby forming an auxiliary manifold 123 (cathode outlet auxiliary manifold). The cathode auxiliary fluid outlet 124 of the auxiliary manifold 123 is connected to the outlet of the cathode flow path 140. The through hole in the flow path plate 14 that forms the auxiliary manifold 123 is closed at the end on the positive side of the Z axis in FIG. 4. The closure may be performed using a not-illustrated packing or gasket. The end of the through hole provided at the side surface of the support plate 18 functions as the end of the cathode auxiliary fluid outlet 124.

An auxiliary connecting flow path is provided between the auxiliary manifold 121 and the cathode flow path 140 of each of the electrolysis cells 110, and a flow parallel to the X-Y plane is formed. This allows a cathode auxiliary fluid to be supplied to the cathode flow paths 140 of the respective electrolysis cells 110. The auxiliary connecting flow path may be formed by machining a portion of the flow path plate 14 or the flow path plate 16. The connecting flow path connecting the fluid manifold 103 and the cathode flow path 140 may be independent of the auxiliary connecting flow path connecting the auxiliary manifold 121 and the cathode flow path 140. The auxiliary connecting flow path may merge with the main connecting flow path midway. Similarly, an auxiliary connecting flow path is provided between the auxiliary manifold 123 and the cathode flow path 140 of each of the electrolysis cells 110, and a flow parallel to the X-Y plane is formed. This allows the cathode auxiliary fluids to be discharged from the cathode flow paths 140 of the respective electrolysis cells 110 to the auxiliary manifold 123. The auxiliary connecting flow path may be formed by machining a portion of the flow path plate 14 or the flow path plate 16. The connecting flow path connecting the fluid manifold 105 and the cathode flow path 140 may be independent of the auxiliary connecting flow path connecting the auxiliary manifold 123 and the cathode flow path 140. The auxiliary connecting flow path may merge with the main connecting flow path midway.

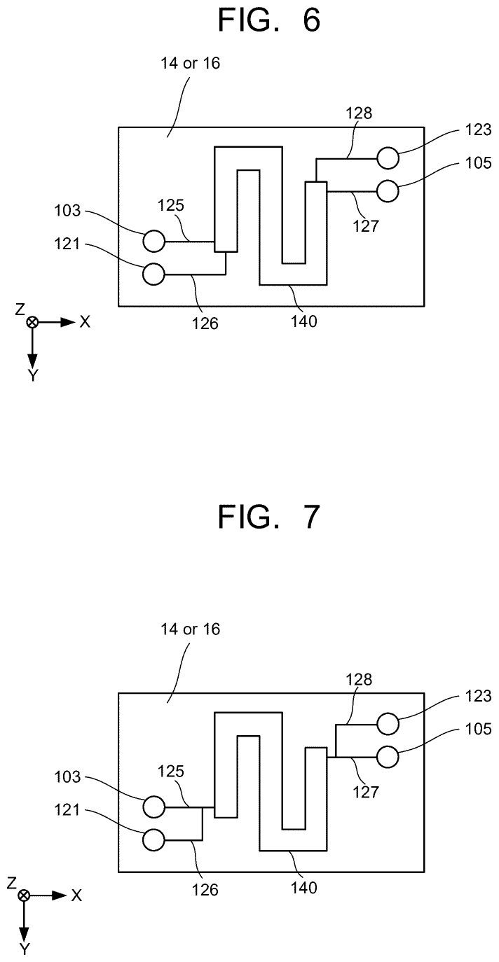

FIG. 6 and FIG. 7 are schematic views each explaining a structure example when the flow path plate 14 or the flow path plate 16 is viewed from the negative side of the Z axis in FIG. 4 and FIG. 5. For ease of viewing, the fluid paths related to the anode 12 are omitted in FIG. 6 and FIG. 7. FIG. 6 illustrates an example of the case where a connecting flow path 125 connecting the fluid manifold 103 and the cathode flow path 140 and an auxiliary connecting flow path 126 connecting the auxiliary manifold 121 and the cathode flow path 140 are independent, and a connecting flow path 127 connecting the fluid manifold 105 and the cathode flow path 140 and an auxiliary connecting flow path 128 connecting the auxiliary manifold 123 and the cathode flow path 140 are independent. FIG. 7 illustrates an example of the case where the auxiliary connecting flow path 126 merges with the connecting flow path 125 midway, and the auxiliary connecting flow path 128 merges with the connecting flow path 127 midway.

The support plate 18 may be molded to fit with the support plate 17 of another adjacent sub-stack 100. In particular, in the portions where through holes are provided to pass through the support plate 17 and the support plate 18 in the Z-axis direction and these through holes are connected in the sub-stacks 100 adjacent to each other to form the fluid manifold 103 and the fluid manifold 105, the portions that form the through holes may be molded to fit together. A member such as a packing whose illustration is omitted may be sandwiched between the support plate 17 and a member adjacent thereto and between the support plate 18 and a member adjacent thereto as necessary.

The clamping plates 111 in a pair are located at the outer edge of the electrolysis cell stack 10, sandwiching the plural sub-stacks 100 therebetween. Even when the support plate 17 and the support plate 18 have a component for clamping each individual sub-stack 100, it is preferable that the clamping plates 111 in a pair should have a certain clamping force. This increases the adhesion between the sub-stacks 100, to make it possible to prevent liquid or gas from leaking through the gaps between the sub-stacks 100, and further reduce the electrical resistance between the sub-stacks 100 when the sub-stacks 100 are electrically connected to each other.

Similarly to the electrolysis cell stack 10 illustrated in FIG. 2 and FIG. 3, also in the electrolysis cell stack 10 illustrated in FIG. 4 and FIG. 5, the power supply from the power supply 20 may be performed on the entire electrolysis cell stack 10 collectively or individually on each sub-stack 100.

In the electrolysis cell stack 10 illustrated in FIG. 4, the fluid path required for normal operations is the cathode fluid path that includes the fluid manifold 103 and the fluid manifold 105 passing through the electrolysis cell stack 10 (FIG. 5). On the other hand, the auxiliary manifold 121 and the auxiliary manifold 123 are completed within the sub-stack 100, and therefore, the cathode auxiliary fluid path is formed for each sub-stack 100 (FIG. 5). It is possible to perform operations only on a specific sub-stack 100 by using the auxiliary manifold 121 and the auxiliary manifold 123 formed for each sub-stack 100. For example, while operating the electrolysis cell stack 10 using the main cathode fluid path, the cathode supply fluid can be additionally supplied only to a specific sub-stack 100 by using the auxiliary manifold 121. As an example, in the carbon dioxide electrolysis, a phenomenon has been known in which when the diffusivity of a cathode gas diffusion layer is low, the supply of carbon dioxide to a catalyst does not occur easily, and hydrogen generation being a side reaction progresses, resulting in a decrease in target product selectivity. When there are variations in the characteristics between the sub-stacks 100, carbon dioxide is additionally supplied only to the sub-stack 100 with low selectivity from the auxiliary manifold 121, and thereby the outlet gas compositions of the respective sub-stacks 100 can be made uniform. In particular, in such a case where variations in the characteristics of the sub-stacks 100 included in one electrolysis cell stack 10 are large due to rearrangement of the sub-stack 100, the effect of maintaining the quality of the gas generated in the electrochemical reaction device can be expected.

The auxiliary manifold 121 can also be used for the refresh operation. For example, it is possible to supply a rinse solution only to a specific sub-stack 100. The rinse solution is supplied only to the necessary sub-stack 100, and thereby, the refresh operation can be performed with a small amount of rinse solution. Further, it is possible to prevent unexpected performance deterioration caused by supplying a rinse solution to a sound sub-stack 100.

It is also possible to use the auxiliary manifold 123 to collect the cathode outlet fluid for each sub-stack 100. This allows the values of performance indices such as product selectivity and Faraday efficiency to be obtained for each sub-stack 100. The values of product selectivity and Faraday efficiency for each sub-stack 100 can be utilized for diagnosing the deterioration state of the sub-stack 100, predicting its lifetime, formulating a maintenance plan, and so on, and the effects of contributing to improving the accuracy of the deterioration state diagnosis, lifetime prediction, and formulating a maintenance plan can be expected. When the fluid manifold 105 and the auxiliary manifold 123 coexist as in FIG. 4 and FIG. 5, the cathode fluid outlet 107 connected to the fluid manifold 105 is closed, thereby making it possible to discharge the cathode outlet fluid from the cathode auxiliary fluid outlets 124 of the respective sub-stacks 100.

In the example of the embodiment illustrated in FIG. 4 and FIG. 5, the fluid manifold 103 and the fluid manifold 105 pass through the entire electrolysis cell stack 10. However, when the electrolysis cell stack 10 includes three or more sub-stacks 100, the fluid manifold 103 and the fluid manifold 105 do not need to extend throughout the entire electrolysis cell stack 10, and a plurality of manifolds passing through several of the sub-stacks 100 may be provided. For example, when there are four sub-stacks 100, a fluid manifold 103 that passes through two of the sub-stacks 100 and is completed may be provided and a fluid manifold 103 that passes through the remaining two sub-stacks 100 and is completed may be provided.

Although not illustrated in FIG. 4, FIG. 5, FIG. 6, and FIG. 7, an anode fluid path and an anode auxiliary fluid path can be constructed on the anode 12 side in the same manner as on the cathode 11 side. That is, the fluid manifold 104 and the fluid manifold 106 passing through the entire electrolysis cell stack 10 may be provided, and an anode inlet auxiliary manifold and an anode outlet auxiliary manifold that are completed within the sub-stack 100 may also be provided. The auxiliary fluid path that is completed within the sub-stack 100 is provided in the anode system, thereby making it possible to regulate the flow rate or temperature of the anode inlet fluid for each sub-stack 100 and collect the anode discharge fluid for each sub-stack 100.

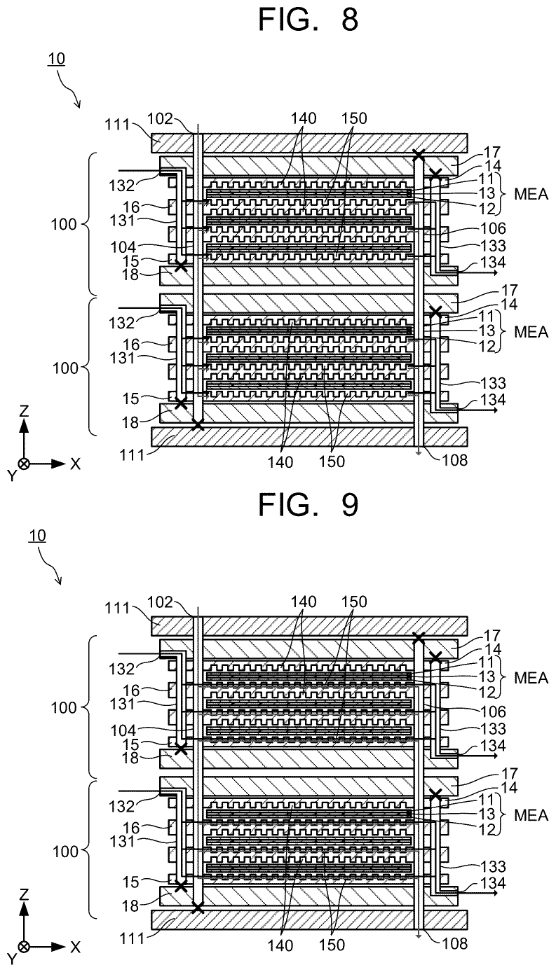

FIG. 8 is a schematic view illustrating another structure example of the electrolysis cell stack 10 of the electrochemical reaction device 1. FIG. 9 is a view illustrating the anode fluid path and an anode auxiliary fluid path in the electrolysis cell stack 10 in FIG. 8. For ease of viewing, illustration of the fluid paths related to the cathode 11 is omitted in FIG. 8 and FIG. 9.

FIG. 8 illustrates three through holes in each of the support plates 17 and 18. Two of them are through holes in the Z-axis direction in FIG. 8, and are connected to the through holes in the Z-axis direction provided in the flow path plate 14, the flow path plate 15, and the flow path plate 16 to form the fluid manifold 104 and the fluid manifold 106. The fluid manifold 104 is also connected to a through hole in the Z-axis direction provided in the upper clamping plate 111 in FIG. 8, and this portion functions as the end of the anode fluid inlet 102. The lower end of the fluid manifold 104 is closed. This closure may be performed using a not-illustrated packing or gasket. The fluid manifold 106 is connected to a through hole in the Z-axis direction provided in the lower clamping plate 111 in FIG. 8, and this portion functions as the end of the anode fluid outlet 108. The upper end of the fluid manifold 106 is closed. This closure may be performed using a not-illustrated packing or gasket.

The fluid manifold 104 passes through the entire electrolysis cell stack 10 and supplies the anode supply fluid to the electrolysis cells 110 of all the sub-stacks 100. A connecting flow path is provided between the fluid manifold 104 and the anode flow path 150 of each of the electrolysis cells 110, and a flow parallel to the X-Y plane is formed. This allows the anode supply fluid to be supplied to the anode flow paths 150 of the respective electrolysis cells 110. The connecting flow path may be formed by machining a portion of the flow path plate 15 or the flow path plate 16.

The fluid manifold 106 passes through the entire electrolysis cell stack 10 and forms a path for the anode discharge fluids discharged from the electrolysis cells of all the sub-stacks 100. A connecting flow path is provided between the fluid manifold 106 and the anode flow path 150 of each of the electrolysis cells 110, and a flow parallel to the X-Y plane is formed. This allows the anode discharge fluids to be discharged from the anode flow paths 150 of the respective electrolysis cells 110 to the fluid manifold 106. The connecting flow path may be formed by machining a portion of the flow path plate 15 or the flow path plate 16.

The remaining one of the three through holes provided in the support plate 17 is a through hole that forms an anode auxiliary fluid inlet 132, with one end of the through hole provided at the surface of the support plate 17 that is in contact with the flow path plate 14 and the other end thereof provided at the side surface of the support plate 17. This through hole is connected to a through hole provided to pass through the adjacent flow path plate 14 in the Z-axis direction, and is further connected to through holes provided in the flow path plate 16 and the flow path plate 15, thereby forming an auxiliary manifold 131 (anode inlet auxiliary manifold). The anode auxiliary fluid inlet 132 of the auxiliary manifold 131 is connected to the inlet of the anode flow path 150. The through hole in the flow path plate 15 that forms the auxiliary manifold 131 is closed at the end on the negative side of the Z axis in FIG. 8. The closure may be performed using a not-illustrated packing or gasket. The end of the through hole provided at the side surface of the support plate 17 functions as the end of the anode auxiliary fluid inlet 132.

The remaining one of the three through holes provided in the support plate 18 is a through hole that forms an anode auxiliary fluid outlet 134, with one end of the through hole provided at the surface of the support plate 18 that is in contact with the flow path plate 15 and the other end thereof provided at the side surface of the support plate 18. This through hole is connected to a through hole provided to pass through the adjacent flow path plate 15 in the Z-axis direction, and is further connected to through holes provided in the flow path plate 16 and the flow path plate 14, thereby forming an auxiliary manifold 133 (anode outlet auxiliary manifold). The anode auxiliary fluid outlet 134 of the auxiliary manifold 133 is connected to the outlet of the anode flow path 150. The through hole in the flow path plate 14 that forms the auxiliary manifold 133 is closed at the end on the positive side of the Z axis in FIG. 8. The closure may be performed using a not-illustrated packing or gasket. The end of the through hole provided at the side surface of the support plate 18 functions as the end of the anode auxiliary fluid outlet 134.

An auxiliary connecting flow path is provided between the auxiliary manifold 131 and the anode flow path 150 of each of the electrolysis cells 110, and a flow parallel to the X-Y plane is formed. This allows the anode auxiliary fluid to be supplied to the anode flow paths 150 of the respective electrolysis cells 110. The auxiliary connecting flow path may be formed by machining a portion of the flow path plate 15 or the flow path plate 16. The connecting flow path connecting the fluid manifold 104 and the anode flow path 150 may be independent of the auxiliary connecting flow path connecting the auxiliary manifold 131 and the anode flow path 150. The auxiliary connecting flow path may merge with the main connecting flow path midway.

An auxiliary connecting flow path is provided between the auxiliary manifold 133 and the anode flow path 150 of each of the electrolysis cells 110, and a flow parallel to the X-Y plane is formed. This allows the anode auxiliary fluids to be discharged from the anode flow paths 150 of the respective electrolysis cells 110 to the auxiliary manifold 133. The auxiliary connecting flow path may be formed by machining a portion of the flow path plate 15 or the flow path plate 16. The connecting flow path connecting the fluid manifold 106 and the anode flow path 150 may be independent of the auxiliary connecting flow path connecting the auxiliary manifold 133 and the anode flow path 150. The auxiliary connecting flow path may merge with the main connecting flow path midway.

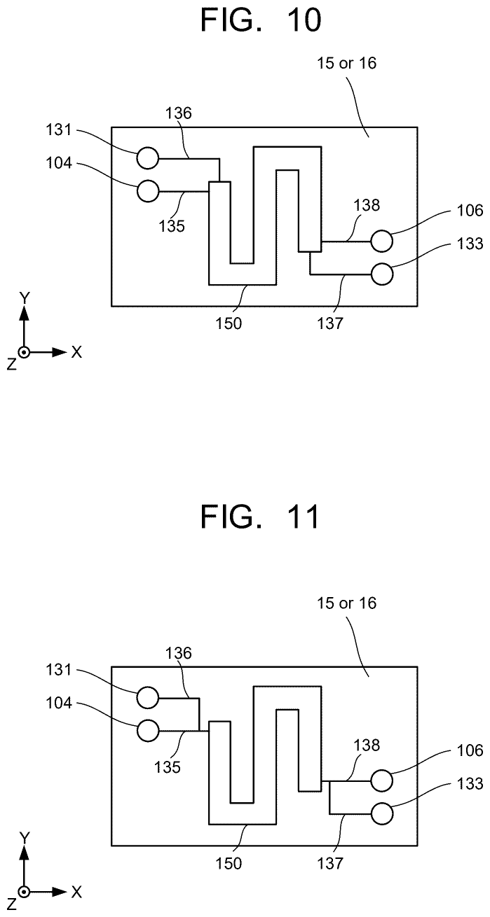

FIG. 10 and FIG. 11 are schematic views each explaining a structure example when the flow path plate 15 or the flow path plate 16 is viewed from the positive side of the Z axis in FIG. 8 and FIG. 9. FIG. 10 illustrates an example of the case where a connecting flow path 135 connecting the fluid manifold 104 and the anode flow path 150 and an auxiliary connecting flow path 136 connecting the auxiliary manifold 131 and the anode flow path 150 are independent, and a connecting flow path 137 connecting the fluid manifold 106 and the anode flow path 150 and an auxiliary connecting flow path 138 connecting the auxiliary manifold 133 and the anode flow path 150 are independent. FIG. 11 illustrates an example of the case where the auxiliary connecting flow path 136 merges with the connecting flow path 135 midway, and the auxiliary connecting flow path 138 merges with the connecting flow path 137 midway.

The support plate 18 may be molded to fit with the support plate 17 of another adjacent sub-stack 100. In particular, in the portions where through holes are provided to pass through the support plate 17 and the support plate 18 in the Z-axis direction and these through holes are connected in the sub-stacks 100 adjacent to each other to form the fluid manifold 104 and the fluid manifold 106, the through hole portions may be molded to fit together. A member such as a packing whose illustration is omitted may be sandwiched between the support plate 17 and a member adjacent thereto and between the support plate 18 and a member adjacent thereto as necessary.

Also in the electrolysis cell stack 10 illustrated in FIG. 8 and FIG. 9, the power supply from the power supply 20 may be performed on the entire electrolysis cell stack 10 collectively or individually on each sub-stack 100, similarly to the electrolysis cell stack 10 illustrated in FIG. 2 and FIG. 3.

In the electrolysis cell stack 10 illustrated in FIG. 8, the fluid path required for normal operations is the anode fluid path including the manifold that passes through the electrolysis cell stack 10 (FIG. 9). On the other hand, the auxiliary manifold 131 and the auxiliary manifold 133 are completed within the sub-stack 100, and therefore the anode auxiliary fluid path is formed for each sub-stack 100 (FIG. 9). By using the auxiliary manifold 131 and the auxiliary manifold 133 formed for each sub-stack 100, operations can be performed only on a specific sub-stack 100. For example, while operating the electrolysis cell stack 10 using the main anode fluid path, the anode supply fluid can be additionally supplied only to a specific sub-stack 100 by using the auxiliary manifold 131. As an example, when the flow rate of the aqueous solution to be supplied to the anode flow path 150 is low, the effect of removing reaction heat through heat exchange is impaired, causing the cell temperature to rise, which may result in a decrease in the target product selectivity or accelerated deterioration of members. When there are variations in the characteristics between the sub-stacks 100, an aqueous solution is additionally supplied from the auxiliary manifold 131 only to the sub-stack 100 with a higher temperature, thereby making it possible to make the outlet gas compositions of the sub-stacks 100 uniform and make the degree of deterioration uniform. In particular, in such a case where variations in the characteristics of the sub-stacks 100 included in one electrolysis cell stack 10 are large due to rearrangement of the sub-stack 100, it is possible to expect the effects of maintaining the quality of the gas generated in the electrochemical reaction device 1 and extending the lifetime of the electrolysis cell stack 10.

The auxiliary manifold 131 can also be used for the refresh operation. For example, it is possible to supply a rinse solution only to a specific sub-stack 100. The rinse solution is supplied only to the necessary sub-stack 100, and thereby, the refresh operation can be performed with a small amount of rinse solution. Further, it is possible to prevent unexpected performance deterioration caused by supplying a rinse solution to a sound sub-stack 100.

It is also possible to use the auxiliary manifold 133 to collect the anode outlet fluid for each sub-stack 100. This allows the values of performance indices such as product selectivity and Faraday efficiency to be obtained for each sub-stack 100. The values of product selectivity and Faraday efficiency for each sub-stack 100 can be utilized for diagnosing the deterioration state of the sub-stack 100, predicting its lifetime, formulating a maintenance plan, and so on, and the effects of contributing to improving the accuracy of the deterioration state diagnosis, lifetime prediction, and formulating a maintenance plan can be expected. When the fluid manifold 106 and the auxiliary manifold 133 coexist as in FIG. 8 and FIG. 9, the anode fluid outlet 108 connected to the fluid manifold 106 is closed, thereby making it possible to discharge the anode outlet fluid from the anode auxiliary fluid outlets 134 of the respective sub-stacks 100.

In the example of the embodiment illustrated in FIG. 8 and FIG. 9, the fluid manifold 104 and the fluid manifold 106 pass through the entire electrolysis cell stack 10. However, when the electrolysis cell stack 10 includes three or more sub-stacks 100, the fluid manifold 104 and the fluid manifold 106 do not need to extend throughout the entire electrolysis cell stack 10, and a plurality of manifolds passing through several of the sub-stacks 100 may be provided. For example, when there are four sub-stacks 100, a fluid manifold 104 that passes through two of the sub-stacks 100 and is completed and a fluid manifold 104 that passes through the remaining two sub-stacks 100 and is completed may be provided.

### Other Manifold Configurations

The electrolysis cell stack 10 includes the manifolds that are completed within the sub-stack 100, but the embodiment is not limited to the above example.

For example, in FIG. 2 and FIG. 3, the manifold is completed within the sub-stack 100 on both the inlet side and the outlet side, but it is also possible to employ a configuration in which a manifold that is completed within the sub-stack 100 only on one side thereof and passes through the entire electrolysis cell stack 10 on the other side thereof is installed. On the side having the manifold that passes through the entire electrolysis cell stack 10, an auxiliary manifold that is completed within the sub-stack 100 may be further provided.

In FIG. 4, FIG. 5, FIG. 8, and FIG. 9, the case where the auxiliary manifold for auxiliary fluid is provided on both the inlet side and the outlet side has been explained, but the auxiliary manifold may be provided only on one of the inlet side and the outlet side.

Manifolds with different types and structures for the anode system and the cathode system may be provided. For example, the cathode fluid path may include a manifold that is completed within the sub-stack 100, and the anode fluid path may include a manifold that passes through the entire electrolysis cell stack 10.

In either case, the power supply to the electrolysis cell stack 10 may be performed on the entire electrolysis cell stack 10 collectively or individually on each sub-stack 100.

The power supply 20 is electrically connected to the cathodes 11 and the anodes 12 of the respective electrolysis cells 110 via the flow path plate 14, the flow path plate 15, the flow path plate 16, the support plate 17, and the support plate 18, for example. The power supply 20 can apply electric power for causing an electrolytic reaction such as an oxidation reaction or a reduction reaction to the electrolysis cell stack 10. The electric energy supplied from the power supply 20 is used to cause a reduction reaction at the cathode 11 and an oxidation reaction at the anode 12. When the current collector is included, the power supply 20 and the current collector are connected by wiring, for example. Between the electrolysis cell stack 10 and the power supply 20, electric devices such as inverters, converters, and batteries may be installed as necessary. The electrolysis cell stack 10 may be driven by a constant-voltage system or a constant-current system.

The power supply 20 may be an ordinary commercial power supply, a battery, or the like, or may be a power supply that converts renewable energy to electric energy and supplies it. Examples of such a power supply include a power supply that converts kinetic energy or potential energy such as wind power, water power, geothermal power, or tidal power to electric energy, a power supply such as a solar cell including a photoelectric conversion element that converts light energy to electric energy, a power supply such as a fuel cell or a storage battery that converts chemical energy to electric energy, and a power supply such as an apparatus that converts vibrational energy such as sound to electric energy. The photoelectric conversion element has a function of performing charge separation by emitted light energy of sunlight or the like. Examples of the photoelectric conversion element include a pin-junction solar cell, a pn-junction solar cell, an amorphous silicon solar cell, a multijunction solar cell, a single crystal silicon solar cell, a polycrystalline silicon solar cell, a dye-sensitized solar cell, an organic thin-film solar cell, and so on. Further, the photoelectric conversion element may be stacked on at least one of the cathode 11 and the anode 12 inside an electrolytic part.

The measuring device 30 can measure a physical quantity related to the state of at least one sub-stack 100. Examples of the measuring device 30 include a thermometer, a pressure gauge, a dew-point meter, an ammeter, a voltmeter, a resistance meter, an impedance measuring device, a gas flowmeter, a gas composition analyzer, a liquid flowmeter, a liquid composition analyzer, and so on, but the measuring device 30 is not limited to these. Examples of the physical quantities to be measured by the measuring device 30 include temperature, pressure, dew point, current, voltage, resistance value, AC impedance, fluid flow rate, fluid composition, and so on.

The measuring device 30 may be attached to the members of the sub-stack 100, or to the pipes and wirings connected to them. For example, a thermocouple for measuring temperature can be installed on the support plate 17 or the support plate 18. Examples of the method of installation include a method of inserting a sheath of a thermocouple into a hole provided in the support plate 17 or the support plate 18, but the method is not limited to this. For the purpose of measuring the physical quantities of the cathode supply fluid, the anode supply fluid, the cathode discharge fluid, and the anode discharge fluid, for example, a thermometer, a pressure gauge, a dew-point meter, and a flowmeter can be installed in the pipes connected to the cathode fluid inlet 101, the cathode fluid outlet 107, the anode fluid inlet 102, and the anode fluid outlet 108 that are provided for each sub-stack 100.

The measuring device 30 may indirectly measure the physical quantity related to the sub-stack 100. For example, when analyzing the composition of a gas that is the cathode discharge fluid of a certain sub-stack 100, a gas composition analyzer may be connected directly to a pipe connected to the cathode fluid outlet 107. Alternatively, the gas may be collected in a gas bag or the like and the composition of the gas may be analyzed using a gas analyzer that is not directly connected to the sub-stack 100.

When an impedance measuring device is used as the measuring device 30, it is preferable that at least one sub-stack 100 should include potential terminals. The potential terminal enables the voltage of that sub-stack 100 to be measured separately from the voltage of the entire electrolysis cell stack 10. For example, AC impedance data (impedance data) can be acquired by superimposing an AC current on the DC current flowing through the electrolysis cell stack 10, monitoring the voltage of the sub-stack 100 at that time, and processing data on the current and voltage.

The potential terminal of the sub-stack 100 may be provided on the support plate 17 and the support plate 18, or on the flow path plate 14 and the flow path plate 15. The potential terminal is preferably electrically connected to the outermost electrode (the electrode located on the same side of the diaphragm 13 as the flow path plates 14 and 15) of the electrolysis cell 110 at the end of the sub-stack 100 via the support plate 17, the support plate 18, or the flow path plate 14, the flow path plate 15.

Regarding the potential terminal of the sub-stack 100, a plurality of potential terminals may be provided for one sub-stack 100. For example, each one potential terminal may be provided on the support plate 17 and on the support plate 18 of one sub-stack 100. For example, each one potential terminal may be provided on the flow path plate 14 and on the flow path plate 15 of one sub-stack 100. For example, a plurality of potential terminals may be provided on one of the support plates 17 and 18, and a plurality of potential terminals may be provided on one of the flow path plates 14 and 15. In this case, by measuring the potential at different positions within the X-Y plane and acquiring impedance data, it is possible to extract information on at which position and what kind of deterioration is occurring within the X-Y plane of the sub-stack 100.

The potential terminal may be provided for each of the electrolysis cells 110 that form the sub-stack 100. In this case, the potential terminal is preferably provided on the flow path plate 14, the flow path plate 15, and the flow path plate 16. A plurality of potential terminals may be provided for one electrolysis cell 110. A plurality of potential terminals may be provided on the single flow path plate 14, flow path plate 15, or flow path plate 16. In this case, by measuring the potential at different positions within the X-Y plane and acquiring impedance data, it is possible to extract information on at which position and what kind of deterioration is occurring within the X-Y plane of the electrolysis cell 110.

By superimposing an AC current on the DC current flowing through the electrolysis cell stack 10 and monitoring the voltage of the entire electrolysis cell stack 10 at this time, impedance data on the entire electrolysis cell stack 10 can be acquired. When measuring the voltage of the entire electrolysis cell stack 10, a busbar, which is a part of the current collector, may be used as the potential terminal of the electrolysis cell stack 10, or a potential terminal provided on the flow path plate 14, the flow path plate 15, the support plate 17, or the support plate 18 of the sub-stack 100 located at the outermost edge may be used as the potential terminal of the electrolysis cell stack 10.

The information processing unit 40 is configured to process physical quantity data on the state of at least one sub-stack 100 obtained as a result of the measurement. The information processing unit 40 can generate output information based on the physical quantity data by receiving signals of the physical quantity data acquired by the measuring device 30 and performing calculations. The information processing unit 40 may process physical quantity data on the entire electrolysis cell stack 10 in addition to the physical quantity data on the state of at least one sub-stack 100. Examples of the physical quantity data on the entire electrolysis cell stack 10 include the AC impedance of the electrolysis cell stack 10.

The information processing unit 40 is configured using hardware using a processor or the like, for example. Each operation may be stored in advance as an operation program in a computer-readable recording medium such as a memory, and each operation may be executed by the hardware appropriately reading the operation program stored in the recording medium.

The information processing unit 40 may read and process information stored in a recording medium. The information stored in the recording medium is information on the electrochemical reaction device 1 stored in a database described below, for example. The information stored in the recording medium is information on history of operation of the same or different type of electrochemical reaction device other than the electrochemical reaction device 1, or the like, for example.

The information processing unit 40 is configured to process the physical quantity data on at least one sub-stack 100, for example, thereby making it possible to diagnose the deterioration state of at least one sub-stack 100.

The diagnosis of the deterioration state of the sub-stack 100 may involve determining the presence or absence of deterioration, classifying the type and degree of deterioration into plural categories and determining a corresponding category, or quantitatively evaluating the degree of deterioration.

As an index for quantitatively evaluating the degree of deterioration of the sub-stack 100, for example, performance indices such as the product selectivity, voltage, Faraday efficiency, and electrolysis efficiency of the sub-stack 100 can be used. When it is impossible to directly obtain the values of these performance indices from physical quantity data measurable by the measuring device 30, the relationship between these performance indices and the measurable physical quantity data can be investigated in advance using an electrolysis cell stack equivalent to the sub-stack 100 to estimate the values of the performance indices from the physical quantity data obtained by actually measuring the sub-stack 100 based on that relationship. In order to diagnose the deterioration state, the plural performance indices may be used, and the plural physical quantities may be used. The relationship between the performance indices and the measurable physical quantity data may be explicitly expressed using a function, mathematical table, graph, or the like, or may also be implicitly expressed using a machine learning model, or the like.

The information processing unit 40 can calculate a resistance value by analyzing data on the AC impedance of the sub-stack 100, for example. Finding the variation and/or rate of change in the resistance value makes it possible to determine the deterioration of the sub-stack 100. A threshold value may be set for the resistance value to determine the presence or absence of deterioration. Deterioration of a specific portion of the sub-stack 100 may be determined by measuring the AC impedance at a plurality of frequencies and analyzing the results.

When the cathode discharge fluid can be collected for each sub-stack 100, the deterioration state of the sub-stack 100 can also be diagnosed using the result obtained by analyzing the composition of the cathode discharge fluid for each sub-stack 100. For example, when performing carbon dioxide electrolysis, deterioration of the sub-stack 100 can be determined in the case where the concentration of the target reduction product derived from carbon dioxide decreases and the concentration of hydrogen being a by-product increases. Threshold values may be set for a product concentration, selectivity calculated from the concentration, and the like to determine the presence or absence of deterioration.

When the cathode discharge fluid or the anode discharge fluid can be collected for each sub-stack 100, the deterioration state of a member of the sub-stack 100 can also be understood by using the result obtained by analyzing the elements contained in the cathode discharge fluid or the anode discharge fluid for each sub-stack 100, measuring the ion concentration, or the like. This method is effective when the member of the sub-stack 100 undergoes dissolution, corrosion, physical structural change, or the like during operation, and components derived from the member are mixed into the cathode discharge fluid or the anode discharge fluid.

The information processing unit 40 is configured to process physical quantity data on at least one sub-stack 100, for example, thereby making it possible to predict the lifetime of at least one sub-stack 100. The process of processing the physical quantity data to predict the lifetime of the sub-stack 100 may involve the above-described deterioration state diagnosis process and its results.

For the lifetime prediction of the sub-stack 100, performance indices that enable quantitative evaluation of the degree of deterioration of the sub-stack 100, such as product selectivity, voltage, Faraday efficiency, and electrolysis efficiency can be used. For example, a threshold value may be set for at least one of these performance indices, and when the performance index reaches that threshold value, the sub-stack 100 may be determined to have reached the end of its lifetime. In this case, the value of the performance index at a time beyond the point in time at which the prediction is made is estimated, thereby making it possible to find the time required for the performance index to reach the threshold value and regard this as the remaining lifetime of the sub-stack 100.

As a method of estimating the value of the performance index at a time beyond the prediction point in time, there can be cited a method of fitting the time variation in performance index within a certain operating period prior to the prediction point in time using a function, and then using the function to find the value of the performance index at a time beyond the point in time at which the prediction is made, for example.

It is also possible to measure the time variation in performance index over a long period of time in advance using an electrolysis cell stack equivalent to the sub-stack 100 in the embodiment, and use the result of the measurement to predict the remaining lifetime of the sub-stack 100 in the embodiment. For example, if the time course of the performance index under various operating conditions or member conditions is known, a machine learning model that predicts the lifetime of the sub-stack 100 can be created from the data based on the value of the performance index within a certain operating period.

When the type of physical quantity data that can be measured by the measuring device 30 is limited and the value of the performance index is not directly found from the obtained physical quantity data for the sub-stack 100 in the embodiment, the relationship between measurable physical quantity data and performance indices may be investigated in advance using an electrolysis cell stack equivalent to the sub-stack 100 in the embodiment, and based on the investigated relationship, the value of the performance index may be estimated from the physical quantity data obtained by actually measuring the sub-stack 100 in the embodiment and used for the lifetime prediction. By understanding in advance the relationship between measurable physical quantity data and the remaining lifetime of the sub-stack 100 through prior studies, the remaining lifetime may be estimated directly from the physical quantity data obtained by actually measuring the sub-stack 100 in the embodiment, without using the value of the performance index. The relationship between the measurable physical quantity data and the performance index or the remaining lifetime may be explicitly expressed using a function, mathematical table, graph, or the like, or may also be implicitly expressed using a machine learning model, or the like.

By performing physical quantity measurement and information processing for each sub-stack 100, the deterioration state of each sub-stack 100 can be diagnosed and the lifetime of each sub-stack 100 can be predicted. This makes it possible to specify the sub-stack 100 that has deteriorated particularly severely and the sub-stack 100 that has a particularly short remaining lifetime, preferentially perform maintenance on the specified sub-stack 100, and further avoid performing unnecessary procedures on highly sound sub-stacks 100. This makes it possible to obtain the effect of shortening the time required for maintenance and the effect of reducing costs.

The information processing unit 40 can formulate, based on the results obtained by processing the physical quantity data on at least one sub-stack 100, a maintenance plan for the sub-stack 100 and/or the electrolysis cell stack 10 including the sub-stack 100, for example. The process of processing the physical quantity data to formulate a maintenance plan may involve the above-described is configured to process and results of diagnosing the deterioration state or predicting the lifetime of the sub-stack 100. When formulating the maintenance plan, the maintenance history of the electrolysis cell stack 10 and/or its component member may be considered.

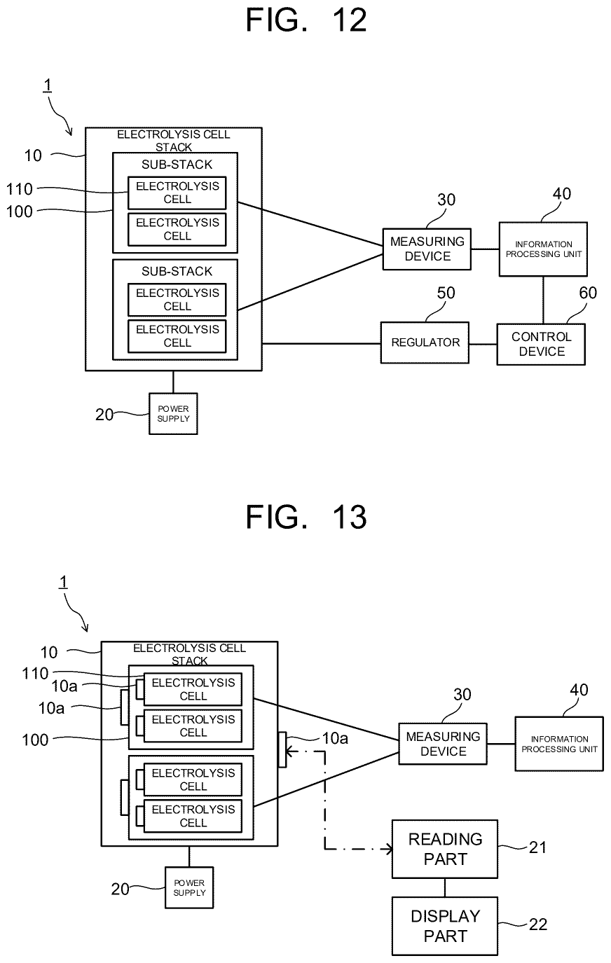

FIG. 12 is a schematic view illustrating another configuration example of the electrochemical reaction device. The electrochemical reaction device 1 may further include a regulator 50 and a control device 60 in addition to the electrolysis cell stack 10, the power supply 20, the measuring device 30, and the information processing unit 40.

The regulator 50 directly or indirectly regulates the state of the electrolysis cell stack 10. Examples of the regulator 50 include a temperature regulator, a pressure regulator, a humidifier, a mass flow controller, a pump, and so on. The temperature regulator includes a heater or a cooler, for example. The temperature regulator can regulate the temperatures of the electrolysis cell stack 10, the sub-stack 100, the cathode supply fluid, and the anode supply fluid, for example. The pressure regulator is a pressure regulating valve provided in a pipe connected to the electrolysis cell stack 10, for example. The pressure regulator can regulate the fluid pressures in the pipe connected to the electrolysis cell stack 10, or in the cathode flow path 140 and in the anode flow path 150 of the electrolysis cell 110, for example, to therefore regulate the inter-electrode differential pressure between the cathode 11 and the anode 12. The humidifier can regulate the dew point of the cathode supply gas, for example. The mass flow controller can regulate the flow rate of the cathode supply gas or the flow rate of the gas to be used in the refresh operation, for example. The pump can regulate the flow rate of the anode supply fluid or the flow rate of the rinse solution to be used in the refresh operation, for example.

The control device 60 is connected to the information processing unit 40, receives signals instructing regulation of physical quantities based on analysis results, and controls the regulator 50. The control device 60 is configured using hardware using a processor, and so on, for example. Each operation may be stored in advance as an operation program in a computer-readable recording medium such as a memory, and each operation may be executed by the hardware appropriately reading the operation program stored in the recording medium.

The maintenance includes changes in the operating conditions, for example. For example, when the analysis by the information processing unit 40 determines that the aqueous solution supplied to the anode flow path 150 is moving excessively to the cathode flow path 140 through the diaphragm 13, the pressure in the cathode flow path 140 can be increased to inhibit the movement of the aqueous solution, or the flow rate of the cathode supply fluid can be increased, thereby performing regulations so that a desired electrochemical reaction is more likely to occur at the cathode 11. The change in the operating condition may be applied to the entire electrolysis cell stack 10, but it is preferable that the sub-stack 100 that requires the change in the operating condition should be specified and the change should be applied to the target sub-stack 100.

The maintenance includes performing the above-described refresh operation, for example. The refresh operation may be performed on the entire electrolysis cell stack 10, but it is preferable that the sub-stack 100 that requires the refresh operation should be specified and the refresh operation should be performed on the target sub-stack 100.

The maintenance includes disassembling the electrolysis cell stack 10 to replace parts or exchange positions, for example. For example, the electrolysis cell stack 10 may be disassembled to take out the plural sub-stacks 100, and the stacking order of these sub-stacks 100 may be changed, or some of the sub-stacks 100 may be replaced with new sub-stacks 100. The new sub-stack 100 may be either brand new and unused or a used one that has already been incorporated into another electrolysis cell stack 10 and used. The plan for replacement or exchange positions of the sub-stacks 100 can be formulated based on the results of the above-described deterioration state diagnosis or lifetime prediction, for example.

There is explained an example of exchanging the positions of the sub-stacks 100 below. The degree of deterioration may differ between the sub-stack 100 located at the end of the electrolysis cell stack 10 and the sub-stack 100 located near the center of the electrolysis cell stack 10 due to differences in heat dissipation during operation, or another reason. The position of the sub-stack 100 located at the end of the electrolysis cell stack 10 is exchanged with the position of the sub-stack 100 located near the center of the electrolysis cell stack 10, thereby making it possible to make the degree of deterioration of the sub-stacks 100 forming the electrolysis cell stack 10 uniform and expect the effect of extending the lifetime of the entire electrolysis cell stack 10.

The sub-stack 100 may be further disassembled, and the positions of the members that form the sub-stack 100, such as, for example, the membrane electrode assembly MEA, the flow path plate 14, the flow path plate 15, and the flow path plate 16, may be exchanged, or some of them may be replaced with new ones.

The replacement or the position exchange of the sub-stack 100 may be performed manually by an operator or by operating a device such as a lifter. Further, a mechanical transport device that is capable of moving the sub-stack 100 in directions parallel and perpendicular to the stacking may be provided, to perform the replacement or the position exchange automatically or semi-automatically.

When the supply of fluid to the sub-stack 100 and the discharge of fluid from the sub-stack 100 are completed and performed for each sub-stack 100 and further, the application of current and voltage is also performed for each sub-stack 100, it is possible to stop the operation of only the sub-stack 100 being a target for maintenance, and take out the target sub-stack 100 from the electrolysis cell stack 10 while the other sub-stacks 100 continue to operate. At that time, a certain level of clamping needs to be maintained for the other sub-stacks 100 that continue to operate. Therefore, in order to perform such an operation, it is preferable that the support plate 17 and the support plate 18 should have a function of clamping the sub-stack 100.

The maintenance may be performed at the discretion of the operator. For example, it is also possible that some of the calculation results in the information processing unit 40 are displayed to the operator via an interface, and the operator views the results and inputs an additional instruction to the information processing unit 40, and the information processing unit 40 then performs additional calculations based on the instruction, or based on both the calculation results and the input instruction, to formulate the maintenance plan.

The calculations in the information processing unit 40 may be calculations using analytical equations, calculations using numerical solutions, or calculations using machine learning. The computational algorithm implemented in the information processing unit 40 can be created based on findings from preliminary experiments, or the like. Further, the algorithm may also be updated based on accumulated data, like machine learning models.

The electrochemical reaction device 1 may include a database. It is possible to record, in the database, physical quantity data on the electrolysis cell stack 10/the sub-stack 100 measured by the measuring device 30. It is possible to record, in the database, the deterioration diagnosis result of the sub-stack 100, the lifetime prediction result, the maintenance plan for the sub-stack 100 and/or the electrolysis cell stack 10, the maintenance history based on the maintenance plan, and the like, which are obtained by analyzing the physical quantity data in the information processing unit 40.

By recording, in the database, information on which sub-stacks 100 the electrolysis cell stack 10 is formed of, information on the electrolysis cell stack 10 can be linked to information on each of the sub-stacks 100 that form the electrolysis cell stack 10.

The database is configured by a recording device such as a memory or a hard disk, for example.

As described above, the electrochemical reaction device in the embodiment has excellent maintainability and is able to selectively take measures such as replacement for the member that is defective or is expected to become defective, for example.

FIG. 13 is a schematic view illustrating another configuration example of the electrochemical reaction device. The electrochemical reaction device 1 may include identification tags 10a.

The identification tag 10a is attached to the entire electrolysis cell stack 10, for example. The identification tag 10a may also be attached individually to at least one of the plural sub-stacks 100. The identification tag 10a may also be attached individually to at least one of the plural electrolysis cells 110.

The identification tag 10a, which is attached to the electrolysis cell stack 10, is attached to the clamping plate 111, for example. The identification tag 10a, which is attached to the electrolysis cell stack 10, can identify the electrolysis cell stack 10. The identification tag 10a, which is attached to the electrolysis cell stack 10, may be attached to the outer surface or side surface of the clamping plate 111, for example.

The identification tag 10a, which is attached to the sub-stack 100, is attached to at least one of the support plate 17 and the support plate 18, for example. The identification tags 10a, which are attached to the respective sub-stacks 100, can identify the respective sub-stacks 100. The identification tag 10a, which is attached to the sub-stack 100, may be attached to at least one side surface of the support plate 17 and the support plate 18 so that it can be visually recognized or read from the outside when the electrolysis cell stack 10 is assembled. At least one portion of the support plate 17 and the support plate 18 may be molded to protrude outward beyond the clamping plate 111, and the identification tag 10a, which is attached to the sub-stack 100, may be attached to the protruded portion. Further, the identification tag 10a, which is attached to the sub-stack 100, may be attached to a plate tied with a string or the like to at least one of the support plate 17 and the support plate 18. These attachment methods are effective methods when the thickness of at least one of the support plate 17 and the support plate 18 is insufficient for attaching the identification tag 10a, which is attached to the sub-stack 100.

The identification tag 10a may be a one-dimensional barcode or a two-dimensional barcode. The identification tag 10a may also be a wireless communication tag. The wireless communication tag may be embedded in a portion that is not easily visually recognized from the outside, for example, inside the clamping plate 111, the support plate 17, or the support plate 18.

The identification tag 10a may be linked to at least one piece of information on the corresponding electrolysis cell stack 10 and sub-stack 100 to be identified in the database. One method of linking information is to assign an identification number to at least one of the electrolysis cell stack 10 and the sub-stack 100 in advance, write the identification number on the identification tag 10a, and also record information on at least one of the corresponding electrolysis cell stack 10 and sub-stack 100 using the identification number on the database side, for example. Another example thereof is a method of forming a database on a network, providing a page in which relevant data are accumulated for each of at least one of the electrolysis cell stack 10 and the sub-stack 100, and recording the address of the page on the identification tag, and the like.

The electrochemical reaction device 1 may include a reading part 21 for reading the identification tag 10a. Examples of the reading part 21 include a barcode reader, a camera, a handy terminal, and so on. Examples of the read results include identification numbers of the electrolysis cell stack 10 to which the corresponding identification tag 10a is attached and its component members, and pieces of information in the database corresponding to the electrolysis cell stack 10 to which the corresponding identification tag is attached and its component members. Here, the component members of the electrolysis cell stack 10 refer to the sub-stack 100, the electrolysis cell 110, and/or component members of the electrolysis cell 110, and so on.

The electrochemical reaction device may include a display part 22. The display part 22 includes a display. The display part 22 may include an interface such as a keyboard, a mouse, or a touch panel. The display part 22 may be connected to the reading part 21 and configured to be able to display the results obtained by reading the identification tag 10a. The display part 22 may also include, as another function, a function of displaying information recorded in the database by search or the like without reading the identification tag 10a. For example, the display part 22 may be designed to enable the operator to use the above-described interface to search for data in the database and display them on a display screen. In addition to the above-described visual display part 22, the electrochemical reaction device may also include a reproducing device that reproduces the results obtained by reading the identification tag 10a and the information in the database in a manner that they are transmitted to the auditory sense or tactile sense. For example, the electrochemical reaction device may include a speaker that emits sound.

The reading part 21 reads the identification tag 10a, and the deterioration diagnosis result, the lifetime prediction result, the maintenance plan, and the like stored in the database are displayed on the display part 22 and/or a display device provided in the reading part 21, thereby enabling the operator to easily learn information on the corresponding electrolysis cell stack 10, sub-stack 100, electrolysis cell 110, or the like. In particular, displaying the maintenance plan helps the operator recognize the need for maintenance and understand the contents of the maintenance plan. When the identification tag 10a is read by the reading part 21, information on the elements that form the target to which the identification tag 10a is attached may be displayed to the operator. For example, when the identification tag 10a attached to the electrolysis cell stack 10 is read, the above-described various pieces of information on the respective sub-stacks 100 that form the electrolysis cell stack 10 may be displayed to the operator.

The identification tag 10a may also be attached to the individual members that form the sub-stack 100 separately. The members that form the sub-stack 100 have similar shapes on the cathode 11 side and the anode 12 side of the electrolysis cell 110, but some of the members have different shapes, resulting in that exchange of the members is impossible in some cases. In such a case, the positions at which the identification tags 10a are attached to these members can be made asymmetrical, or the shape or design of the identification tags 10a themselves can be changed, and thereby the anode-related members and the cathode-related members can be clearly distinguished so as to prevent mix-ups during disassembly or reassembly.

When performing exchange of the position of the electrolysis cell stack 10 or its component member or performing replacement with new ones as maintenance, it can be configured to determine whether the electrolysis cell stack 10 or its component member is the one corresponding to the maintenance plan by reading the identification tag 10a. For example, suppose a maintenance plan is formulated for the electrolysis cell stack 10 in which three sub-stacks 100, namely a sub-stack A, a sub-stack B, and a sub-stack C, are stacked in this order, in which the use of the sub-stack A is stopped, a sub-stack D being a new sub-stack 100, is prepared, and the sub-stacks B, C, and D are stacked in this order. In this case, for example, when the operator reassembles the electrolysis cell stack 10 after being disassembled, the information processing unit can be configured so that a pass determination (stacking work can be performed) is displayed on the display part 22 only when the identification tag 10a of the sub-stack B that should be prepared first is read by the reading part 21, and when the identification tag 10a of another sub-stack is read, a fail determination is made. The determination mechanism may be configured so that after the identification tag 10a of the sub-stack B is read, only the identification tag 10a of the sub-stack C to be stacked next is determined as a pass, and then only the sub-stack D is determined as a pass.

The plural electrolysis cell stacks 10 and their component members are each brought into different deterioration states. Therefore, as described above, by understanding the deterioration state, the estimated remaining lifetime, the maintenance history, and the like of the individual electrolysis cell stacks 10 and/or their component members, and performing maintenance in accordance with these pieces of information, it is possible to maintain the performance of the electrolysis cell stack 10 and extend its lifetime. In this case, the plural electrolysis cell stacks 10 and their component members need to be properly identified and managed. The management using the identification tag 10a exhibits an effect of preventing mix-ups of the electrolysis cell stacks 10 or their component members. The identification tag 10a is linked to the database to thereby further enhance the effects of management and prevention of mix-ups, and therefore the linking is preferably performed.

Note that the above-described configurations in the embodiments are applicable in combination, and parts thereof are also replaceable. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The above-described embodiments can be summarized into the following clauses.

### Clause 1

1 An electrochemical reaction device, comprising:
an electrolysis cell stack including: a pair of clamping plates; and a plurality of sub-stacks stacked between the pair of clamping plates, each of the plural sub-stacks including: a pair of support plates; a plurality of electrolysis cells stacked between the pair of support plates; and at least one fluid manifold completed within one of the plural sub-stacks;
a measuring device configured to measure a physical quantity related to a state of at least one of the plural sub-stacks to acquire physical quantity data; and
an information processing unit configured to process the physical quantity data from the measuring device, wherein
each of the plural electrolysis cells includes: a cathode chamber; an anode chamber; a diaphragm provided between the cathode chamber and the anode chamber; a cathode arranged on the cathode chamber; and an anode arranged on the anode chamber, and
the pair of support plates includes at least four through holes including an inlet or an outlet of the at least one fluid manifold.

### Clause 2

The electrochemical reaction device according to the clause 1, wherein
one of the pair of support plates in one of the plural sub-stacks is fitted to one of the pair of support plates in another one of the plural sub-stacks adjacent to the one of the plural sub-stacks.

### Clause 3

The electrochemical reaction device according to the clause 1 or the clause 2, wherein
the pair of support plates in one of the plural sub-stacks includes a component for clamping the one of the plural sub-stacks.

### Clause 4

The electrochemical reaction device according to any one of the clause 1 to the clause 3, wherein
each of the plural sub-stacks further includes a pair of flow path plates provided between the plural electrolysis cells and the pair of support plates, and
one of the pair of support plates in one of the plural sub-stacks is provided integrally with one of the pair of flow path plates in the one of the plural sub-stacks.

### Clause 5

The electrochemical reaction device according to any one of the clause 1 the clause 4, wherein
each of the plural sub-stacks further includes a flow path plate separating the plural electrolysis cells, and
one of the pair of support plates in one of the plural sub-stacks is thicker than one of the pair of flow path plates and the flow path plate separating the plural electrolysis cells in the one of the plural sub-stacks.

### Clause 6

The electrochemical reaction device according to any one of the clause 1 to the clause 5, wherein
the electrolysis cell stack is configured to perform at least one reduction reaction selected from the group consisting of a reduction reaction of water, a reduction reaction of carbon dioxide, and a reduction reaction of nitrogen.

### Clause 7

The electrochemical reaction device according to any one of the clause 1 to the clause 6, wherein
the information processing unit is configured to process the physical quantity data and thus diagnose a deterioration state of at least one of the plural sub-stacks.

### Clause 8

The electrochemical reaction device according to any one of the clause 1 to the clause 7, wherein
the information processing unit is configured to process the physical quantity data and thus predict a lifetime of at least one of the plural sub-stacks.

### Clause 9

The electrochemical reaction device according to any one of the clause 1 to the clause 8, wherein
a maintenance plan for at least one selected from the group consisting of at least one of the plural sub-stacks and the electrolysis cell stack is formulated based on a result obtained by processing the physical quantity data in the information processing unit.

### Clause 10

The electrochemical reaction device according to the clause 9, further comprising:
a regulator; and
a control device, wherein
the control device is configured to control the regulator based on the maintenance plan.

### Clause 11

The electrochemical reaction device according to the clause 10, wherein
the at least one fluid manifold includes at least one inlet manifold selected from the group consisting of a cathode inlet manifold connected to an inlet of the cathode chamber, a cathode inlet auxiliary manifold connected to the inlet of the cathode chamber, an anode inlet manifold connected to an inlet of the anode chamber, and an anode inlet auxiliary manifold connected to the inlet of the anode chamber, and
the regulator is configured to regulate a condition of a fluid to be supplied to the at least one inlet manifold.

### Clause 12

The electrochemical reaction device according to any one of the clause 1 to the clause 11, wherein
at least one of the plural sub-stacks includes a potential terminal,
the measuring device is configured to measure impedance of the at least one of the plural sub-stacks using the potential terminal, and
the information processing unit is configured to process data on the impedance of the at least one of the plural sub-stacks.

### Clause 13

The electrochemical reaction device according to the clause 12, wherein
a plurality of the potential terminals are provided for at least one of the plural sub-stacks.

### Clause 14

The electrochemical reaction device according to any one of the clause 1 to the clause 13, wherein
the measuring device is configured to measure impedance of the electrolysis cell stack, and
the information processing unit is configured to process data on the impedance of the electrolysis cell stack.

### Clause 15

The electrochemical reaction device according to the clause 9, further comprising:
a database configured to record at least one selected from the group consisting of the physical quantity data, a deterioration diagnosis result of at least one of the plural sub-stacks, a lifetime prediction result of at least one of the plural sub-stacks, the maintenance plan, and a maintenance history based on the maintenance plan.

### Clause 16

The electrochemical reaction device according to any one of the clause 1 to the clause 15, wherein
the electrolysis cell stack includes an identification tag.

### Clause 17

The electrochemical reaction device according to any one of the clause 1 to the clause 16, wherein
each of the plural sub-stacks includes an identification tag.

### Clause 18

The electrochemical reaction device according to the clause 16 or the clause 17, wherein
the identification tag is a one-dimensional barcode, a two-dimensional barcode, or a wireless communication tag.

### Clause 19

The electrochemical reaction device according to any one of the clause 16 to the clause 18, further comprising:
a reading part for reading the identification tag.

### Clause 20

The electrochemical reaction device according to the clause 15, further comprising:
at least one identification tag selected from the group consisting of a first identification tag for identifying the electrolysis cell stack and a second identification tag for identifying each of the plural sub-stacks, wherein
the at least one identification tag is linked to corresponding information in the database, the information on the electrolysis cell stack and/or at least one of the plural sub-stacks to be identified by the at least one identification tag.

### Clause 21

The electrochemical reaction device according to the clause 15, further comprising:
a display part that displays information recorded in the database.

What is claimed is:

1. An electrochemical reaction device, comprising:
an electrolysis cell stack including: a pair of clamping plates; and a plurality of sub-stacks stacked between the pair of clamping plates, each of the plural sub-stacks including: a pair of support plates; a plurality of electrolysis cells stacked between the pair of support plates; and at least one fluid manifold completed within one of the plural sub-stacks;
a measuring device configured to measure a physical quantity related to a state of at least one of the plural sub-stacks to acquire physical quantity data; and
an information processing unit configured to process the physical quantity data from the measuring device, wherein
each of the plural electrolysis cells includes: a cathode chamber; an anode chamber; a diaphragm provided between the cathode chamber and the anode chamber; a cathode arranged on the cathode chamber; and an anode arranged on the anode chamber, and
the pair of support plates includes at least four through holes including an inlet or an outlet of the at least one fluid manifold.

2. The electrochemical reaction device according to claim 1, wherein
the pair of support plates in one of the plural sub-stacks includes a component for clamping the one of the plural sub-stacks.

3. The electrochemical reaction device according to claim 1, wherein
each of the plural sub-stacks further includes a pair of flow path plates provided between the plural electrolysis cells and the pair of support plates, and
one of the pair of support plates in one of the plural sub-stacks is provided integrally with one of the pair of flow path plates in the one of the plural sub-stacks.

4. The electrochemical reaction device according to claim 1, wherein
each of the plural sub-stacks further includes: a pair of flow path plates provided between the plural electrolysis cells and the pair of support plates; and a flow path plate separating the plural electrolysis cells, and
one of the pair of support plates in one of the plural sub-stacks is thicker than one of the pair of flow path plates and the flow path plate separating the plural electrolysis cells in the one of the plural sub-stacks.

5. The electrochemical reaction device according to claim 1, wherein
the electrolysis cell stack is configured to perform at least one reduction reaction selected from the group consisting of a reduction reaction of water, a reduction reaction of carbon dioxide, and a reduction reaction of nitrogen.

6. The electrochemical reaction device according to claim 1, wherein
the information processing unit is configured to process the physical quantity data and thus diagnose a deterioration state of at least one of the plural sub-stacks.

7. The electrochemical reaction device according to claim 1, wherein
the information processing unit is configured to process the physical quantity data and thus predict a lifetime of at least one of the plural sub-stacks.

8. The electrochemical reaction device according to claim 1, wherein
a maintenance plan for at least one selected from the group consisting of at least one of the plural sub-stacks and the electrolysis cell stack is formulated based on a result obtained by processing the physical quantity data in the information processing unit.

9. The electrochemical reaction device according to claim 8, further comprising:
a regulator; and
a control device, wherein
the control device is configured to control the regulator based on the maintenance plan.

10. The electrochemical reaction device according to claim 9, wherein
the at least one fluid manifold includes at least one inlet manifold selected from the group consisting of a cathode inlet manifold connected to an inlet of the cathode chamber, a cathode inlet auxiliary manifold connected to the inlet of the cathode chamber, an anode inlet manifold connected to an inlet of the anode chamber, and an anode inlet auxiliary manifold connected to the inlet of the anode chamber, and
the regulator is configured to regulate a condition of a fluid to be supplied to the at least one inlet manifold.

11. The electrochemical reaction device according to claim 1, wherein
at least one of the plural sub-stacks includes a potential terminal,
the measuring device is configured to measure impedance of the at least one of the plural sub-stacks using the potential terminal, and
the information processing unit is configured to process data on the impedance of the at least one of the plural sub-stacks.

12. The electrochemical reaction device according to claim 11, wherein
a plurality of the potential terminals are provided for at least one of the plural sub-stacks.

13. The electrochemical reaction device according to claim 6, further comprising:
a database configured to record at least one selected from the group consisting of the physical quantity data, a deterioration diagnosis result of at least one of the plural sub-stacks, a lifetime prediction result of at least one of the plural sub-stacks, a maintenance plan for at least one selected from the group consisting of at least one of the plural sub-stacks and the electrolysis cell stack, and a maintenance history based on the maintenance plan.

14. The electrochemical reaction device according to claim 1, wherein
the electrolysis cell stack includes an identification tag.

15. The electrochemical reaction device according to claim 1, wherein
each of the plural sub-stacks includes an identification tag.

16. The electrochemical reaction device according to claim 14, wherein
the identification tag is a one-dimensional barcode, a two-dimensional barcode, or a wireless communication tag.

17. The electrochemical reaction device according to claim 13, further comprising:
at least one identification tag selected from the group consisting of a first identification tag for identifying the electrolysis cell stack and a second identification tag for identifying each of the plural sub-stacks, wherein
the at least one identification tag is linked to corresponding information in the database, the information on the electrolysis cell stack and at least one of the plural sub-stacks to be identified by the at least one identification tag.
